(19) United States
(12) Patent Application Publication
(10) Pub. No.: US 2017/0283090 A1
(43) Pub. Date: Oct. 5, 2017

(54) UNMANNED AERIAL VEHICLE BATTERY SWAPPING SYSTEM

(71) Applicant: Skycatch, Inc., San Francisco, CA (US)

(72) Inventors: Samuel Giles Miller, Folsom, CA (US); Jonathan Shyaun Noorani, Orangevale, CA (US)

(21) Appl. No.: 15/090,452

(22) Filed: Apr. 4, 2016

(51) Int. Cl. B64F 1/36; B60L 11/18; B64C 39/02

(52) U.S. Cl. CPC B64F 1/36; B64C 39/024; B60L 11/1864; B64C 2201/042; B64C 2201/145; B64C 2201/127; B64C 2201/121; B64C 2201/108; B64C 2201/201; B64C 2201/146; B60L 2200/10; B60L 2230/10

(57) ABSTRACT

The present disclosure is directed toward systems and methods for swapping a battery assembly between an unmanned aerial vehicle (UAV) and an unmanned aerial vehicle ground station (UAVGS). In particular, systems and methods described herein enable a battery swapping assembly to remove a battery assembly from within the UAV and store the battery assembly within a plurality of battery banks that are linearly arranged within the UAVGS. For example, the battery arm can move along an axis of movement relative to the battery banks to conveniently transfer one or more battery assemblies between the UAV and the battery banks within the UAVGS.

### BACKGROUND

### 1. Technical Field

One or more embodiments of the present disclosure generally relate to replacing a battery in an unmanned aerial vehicle (UAV). More specifically, one or more embodiments relate to transferring a battery between a UAV and an unmanned aerial vehicle ground station (UAVGS).

### 2. Background and Relevant Art

Aerial photography and videography are becoming increasingly common in providing images and videos in various industries. For example, aerial photography and videography provides tools for construction, farming, real estate, search and rescue, and surveillance. In recent years, UAVs have provided an improved economical approach to aerial photography and videography compared to capturing photos and videos from manned aircraft or satellites.

Conventional UAVs typically include batteries that power various systems within the UAV. For example, UAVs often include one or more batteries that provide power to rotors, cameras, or other systems on board the UAV. Nevertheless, while batteries provide a light and convenient power source for UAVs, batteries are often limited in the amount and duration of power that they provide to the UAV. As such, the distance and duration that a UAV can fly and perform various tasks is limited by battery life.

In some circumstances, UAVs extend range of flight by landing and taking off from remote ground stations (e.g., UAVGSs). Use of remote ground stations, however, causes various complications in recharging and/or replacing batteries from within the landed UAVs. For example, a UAV or UAVGS operator typically travels to the remote ground station and manually removes and replaces a battery when the battery ceases to work or when the battery otherwise needs replacement. Performing remote maintenance on the UAV and/or UAVGS, however, results in considerable expense. In particular, the time and expense required to train an operator and to travel to the remote ground station is cost prohibitive to many companies that benefit from the use of UAVs.

Additionally, UAVs often secure batteries within the UAVs by locking or otherwise securing the batteries within the UAV. For example, a battery is often locked within the UAV to prevent the UAV from accidentally slipping out of the UAV. While locking the battery within the UAV prevents the battery from slipping out, securing the battery using a lock increases the complexity of removing the battery from within the UAV. Additionally, frequently engaging a locking mechanism often causes wear and tear on a battery and/or the UAV. As such, UAVs that include locking mechanisms often result in increased operator maintenance and additional wear and tear on the battery and/or UAV.

Accordingly, there are a number of considerations to be made in transferring a battery between a UAV and UAVGS.

### BRIEF SUMMARY

The principles described herein provide benefits and/or solve one or more of the foregoing or other problems in the art with systems and methods that enable autonomous replacement of a battery from within an unmanned aerial vehicle (UAV). In particular, one or more embodiments described herein include systems and methods that enable a battery arm within an unmanned aerial vehicle ground station (UAVGS) to engage with and conveniently transfer a battery assembly from within a UAV to within the UAVGS. For example, one or more embodiments include a UAVGS having a battery swapping assembly that includes a battery arm that retrieves a battery assembly from the UAV and transfers the batter assembly to one or more battery banks within the UAVGS that are sized to receive the removed battery assembly. The battery swapping assembly then retrieves a new battery assembly (or waits for the removed battery assembly to charge) to put within the UAV.

In particular, when the UAV lands within the landing housing of the UAVGS, the battery arm can engage with the UAV and a battery assembly to remove the battery assembly from within a receiving slot on the UAV. Additionally, the battery arm can insert a new battery assembly within the receiving slot on the UAV. As such, the UAVGS can autonomously replace a battery assembly of UAV and enable multiple flights without frequent operator maintenance.

Furthermore, in one or more embodiments, systems and methods include features and functionality that enable the battery arm to autonomously unlock a battery assembly secured within a receiving slot of a UAV. For example, in engaging the UAV, the battery arm can include one or more latch engagers that engage one or more latches on the UAV and cause the battery assembly to unlock from within the UAV. Once unlocked, the battery arm can include one or more battery grippers that grip a portion of the battery assembly and conveniently retract the unlocked battery from within the UAV.

Additionally, in one or more embodiments, systems and methods include features and functionality that enable the battery arm to swap out a battery assembly within a limited space. For example, one or more embodiments of the battery swapping assembly include a plurality of battery banks that are linearly arranged within the UAVGS and sized to receive the battery assembly. Additionally, one or more embodiments of the battery swapping assembly include an alignment assembly having an actuator that causes the battery arm to move along a first axis with respect to the linearly arranged battery banks. In this way, the battery arm conveniently moves along a single axis and within a limited space constraint of the UAVGS when removing and transferring battery assembly between the UAV and the UAVGS.

Additionally, in one or more embodiments, systems and methods include features and functionality that enable the UAV to engage in extend or multiple flights without user interaction. For example, in one or more embodiments, the UAVGS includes one or more charging interfaces that enable the UAVGS to charge one or more battery assemblies inserted within the plurality of battery banks. When the battery arm removes and stores a battery assembly within one of the battery banks, the battery arm removes a charged replacement battery assembly stored in another battery bank and inserts the replacement battery into the UAV. As such, the UAV can take off and perform additional flights with the charged replacement battery assembly while the UAVGS charges the removed battery assembly stored within the battery banks.

Additional features and advantages of exemplary embodiments will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the embodiments can be obtained, a more particular description of the principles briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of its scope, principles will be described and explained with additional specificity and detail through the use of the accompanying drawings.

FIG. 1 illustrates a side-perspective view of an example unmanned aerial vehicle ground station in accordance with one or more embodiments;

FIG. 2 illustrates a side-perspective view of an example unmanned aerial vehicle in accordance with one or more embodiments;

FIG. 3 illustrates a perspective view of a battery arm in accordance with one or more embodiments;

FIG. 4 illustrates a top view of a portion of a battery arm in accordance with one or more embodiments;

FIG. 5 illustrates a perspective view of a battery assembly within a receiving slot of an unmanned aerial vehicle in accordance with one or more embodiments;

FIG. 6A illustrates a top cross-sectional view of an example battery arm engaging latches of an unmanned aerial vehicle to unlock a battery assembly within the unmanned aerial vehicle in accordance with one or more embodiments;

FIG. 6B illustrates a top cross-sectional view of an example battery arm engaging a battery assembly within an unmanned aerial vehicle in accordance with one or more embodiments;

FIG. 6C illustrates a top cross-sectional view of an example battery arm removing a battery assembly from within an unmanned aerial vehicle in accordance with one or more embodiments;

FIG. 7A illustrates an example battery swapping assembly including a plurality of battery banks in accordance with one or more embodiments;

FIG. 7B illustrates an example battery swapping assembly facilitating transfer of a battery assembly between a UAV and a UAVGS in accordance with one or more embodiments;

FIG. 8A illustrates another example battery swapping assembly including a plurality of battery banks in accordance with one or more embodiments;

FIG. 8B illustrates another example battery swapping assembly facilitating transfer of a battery assembly between a UAV and a UAVGS in accordance with one or more embodiments;

FIG. 9 illustrates a schematic diagram of an autonomous landing system in accordance with one or more embodiments;

FIG. 10 illustrates a flowchart of a series of acts in a method of autonomously replacing a battery assembly from within an unmanned aerial vehicle; and

FIG. 11 illustrates a block diagram of an exemplary computing device in accordance with one or more embodiments.

### DETAILED DESCRIPTION

One or more embodiments described herein relate to an unmanned aerial vehicle (UAV) battery swapping assembly. For example, the UAV battery swapping assembly can be part of an autonomous UAV landing system that allows a UAV to autonomously land within an unmanned aerial vehicle ground station (UAVGS). Once within the UAVGS, UAV battery swapping assembly can autonomously replace a battery assembly within the UAV with a battery assembly from a plurality of battery banks linearly arranged within the UAVGS that are sized to receive the battery assemblies.

Additionally, the battery swapping assembly can include a plurality of battery banks linearly arranged within the UAVGS that are sized to receive the battery assemblies. In one or more embodiments, the battery swapping assembly includes an alignment assembly coupled to the battery arm that includes an actuator. The actuator causes the battery arm to move along an axis of movement and align an end of the battery arm with respect to the linearly arranged battery banks. Aligning the battery arm with the battery banks can enable the battery arm to insert the battery assembly within one of the battery banks.

In addition to enabling autonomous removal of the battery assembly from within the UAV, the autonomous landing system reduces frequency of operator maintenance by enabling autonomous storage of the battery assembly within the UAVGS. For example, when the battery arm engages and removes the battery assembly from within UAV, the battery arm can move along one or more axes and align an end of the battery arm with respect to one or more battery banks arranged within the UAVGS and sized to receive the battery assembly. Once aligned, the battery swapping assembly can cause the battery arm to insert the battery assembly within one of the linearly arranged battery banks for later retrieval via the battery swapping assembly. As such, in addition to removing the battery assembly from within the UAV, the battery swapping assembly can conveniently transfer a used battery assembly from the UAV to a battery bank within the UAVGS without requiring operator maintenance.

Furthermore, the autonomous landing system can include features and functionality that enable the battery arm to autonomously remove and transfer the battery assembly between the UAV and UAVGS within limited space constraints while reducing complexity of the battery swapping assembly. For example, the battery swapping assembly can include a plurality of battery banks that are linearly arranged within the UAVGS and sized to receive the battery assembly. Additionally, the battery swapping assembly can include an actuator that causes the battery arm to align with respect to the battery banks by moving along a single axis of movement. As such, the battery swapping assembly can cause the battery arm to move within the UAVGS along limited axes of movement within limited space constraints provided by the UAVGS.

In addition to facilitating convenient transfer of a battery assembly between a UAV and a UAVGS, the autonomous landing system can further include features and functionality that enables UAVs to perform more frequent flights using replacement battery assemblies that are fully charged. For example, in one or more embodiments, the linearly arranged battery banks include one or more charging contacts that electrically couple to one or more corresponding contacts on the battery assembly when the battery assembly is stored within the battery banks. The UAVGS can further include or couple to a power source that provides a power signal to the stored battery assembly via the charging contacts and cause the battery assembly to charge while stored within the battery banks. Once the battery swapping assembly has removed and inserted a used battery assembly within a battery bank, the battery swapping assembly can cause the battery arm to remove a charged battery from another battery bank and insert the charged battery within the UAV. As such, the UAV can perform another flight immediately upon insertion of the charged battery assembly within the UAV without waiting for the UAV to charge or waiting for the removed battery assembly to charge.

Further, in addition to separate engagement assemblies that prevent wear and tear to the UAV, UAVGS, and battery assembly, one or more embodiments of the battery arm can include one or more sensors that prevent incidental contact between the battery arm and the UAV, UAVGS, or battery assembly. For example, in one or more embodiments, the battery arm includes one or more sensors on an end of the battery arm facing the UAV. When the battery arm extends towards the UAV, the sensors can detect a proximity of the battery arm with respect to the battery assembly and prevent the battery arm from inadvertently coming into contact with and potentially damaging the UAV, UAVGS, battery assembly, or other component within the autonomous landing system.

The term “unmanned aerial vehicle” (“UAV”), as used herein, generally refers to an aircraft that can be piloted autonomously or remotely by a control system. For example, a “drone” is a UAV that can be used for multiple purposes or applications (e.g., military, agriculture, surveillance, etc.). In one or more embodiments, the UAV includes onboard computers that control the autonomous flight of the UAV. In at least one embodiment, the UAV is a multi-rotor vehicle, such as a quadcopter, and includes a carbon fiber shell, integrated electronics, a battery bay (including a battery assembly), a global positioning system (“GPS”) receiver, a fixed or swappable imaging capability (e.g., a digital camera), and various sensors or receivers. The UAV can also include a computing device including programmed instructions that allow the UAV to takeoff, fly, and land autonomously.

The term “unmanned aerial vehicle ground station” (“UAVGS”), as used herein, generally refers to an apparatus from which a UAV can takeoff, and where the UAV can later land and be stored until its next flight. For example, the UAVGS can include a carbon fiber box containing a UAV storage area that functions as a takeoff area and/or a landing pad when the UAV is not being stored. In at least one embodiment, following the autonomous landing of the UAV, one or more systems of the UAVGS can recharge or swap-out one or more batteries of the UAV, download data (e.g., digital photographs, digital videos, sensor readings, etc.) collected by the UAV. In one or more embodiments, the UAVGS allows for wireless communication between the UAVGS and a server to transfer of data collected by the UAV and downloaded to the UAVGS to the server.

The term “battery arm,” as used herein, generally refers to a mechanical apparatus that engages a battery assembly and causes the battery assembly to remove from within a receiving slot of a UAV or battery docking station. For example, the battery arm can include a mechanical arm that extends and retracts. Additionally, the battery arm can include multiple actuators (e.g., motors), plates, rods, screws, pins, links, chains, sensors, pivot points, circuitry, and various assemblies that engage with the UAV and/or battery assembly to facilitate automatic removal and automatic replacement of a battery assembly.

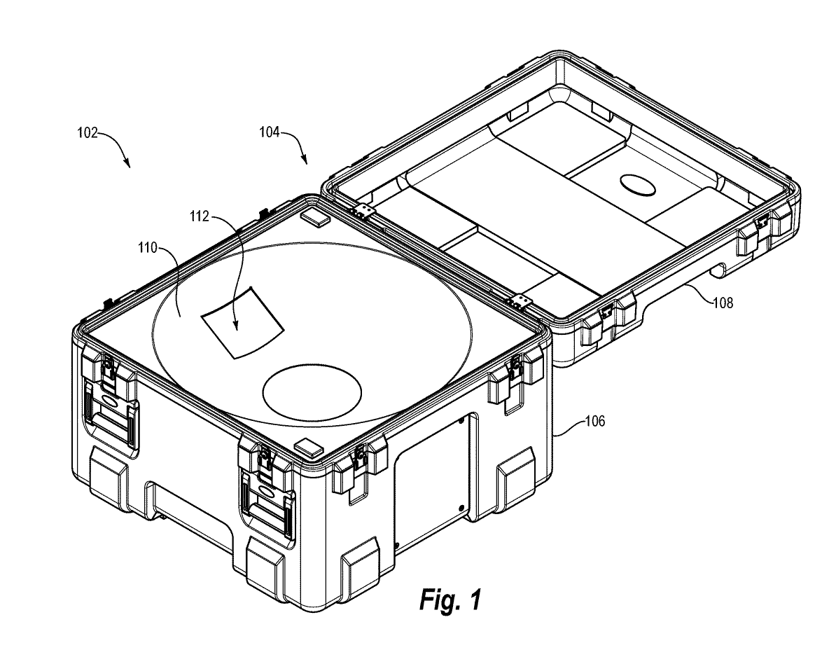

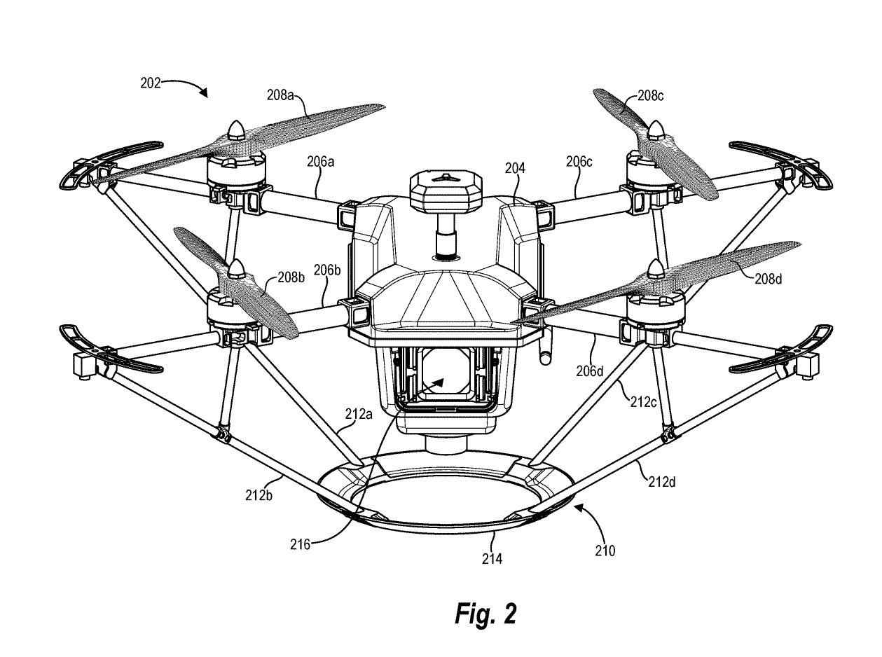

To aid in description of the battery arm and methods of using automatic battery assembly removal and replacement, an overview of an example unmanned aerial vehicle and ground station are first described with reference to FIGS. 1 and 2. One will appreciate that the configuration of the UAV and ground station are exemplary embodiments and the later described battery arm can function with a wide variety of UAVs, ground stations, and battery assemblies. FIGS. 1 and 2 illustrate perspective views of an unmanned aerial vehicle ground station 102 (or simply “UAVGS 102”) and an unmanned aerial vehicle 202 (or simply “UAV 202”) that lands within the UAVGS 102. For example, as shown in FIG. 1, the UAVGS 102 includes a housing 104 including a base 106 and a hinged lid 108. In one or more alternative embodiments, the UAVGS 102 can have a different shape or configuration. For example, the UAVGS 102 may lack a lid and include additional or alternative features.

Additionally, as illustrated in FIG. 1, the UAVGS 102 includes a landing housing 110. As shown in FIG. 1, the landing housing 110 includes an opening toward a top surface of the base 106 and a floor of the landing housing 110 that makes up a bottom surface of the landing housing 110. Further, as shown in FIG. 1, the landing housing 110 has a shape that extends downward and inward from the opening of the landing housing 110 at the top of the base 106 toward a circular floor of the landing housing 110. In one or more embodiments, the UAVGS 102 includes a single landing housing 110 shaped to receive a single UAV 202 within the UAVGS 102. Alternatively, the UAVGS 102 can include multiple landing housings 110 having similar or different shapes and sizes.

While FIG. 1 illustrates one example in which the landing housing 110 has a conical shape, it is appreciated that the landing housing 110 can have a variety of different shapes and sizes. In any event, in one or more embodiments, the landing housing 110 has a complimentary shape to a landing base of a UAV. As such, the UAV fits within the complimentary-shaped landing housing 110 when the UAV lands within the UAVGS 102. In one or more embodiments, the landing housing 110 includes a shape that enables the UAV to fit within the landing housing 110 and align within the landing housing 110. Additionally, in one or more embodiments, the landing housing 110 includes a shape (e.g., symmetrical shape) that slants downward and inward from the opening at the top of the base 106 toward the floor of the landing housing 110 to enable the UAV to self-align within the landing housing 110 as the UAV comes into contact with and lands within the UAVGS 102.

Additionally, as shown in FIG. 1, the UAVGS 102 further includes an opening 112 in a wall of the landing housing 110. In particular, the landing housing 110 can include one or more openings 112 through which a portion of a battery arm passes and engages the UAV and/or battery assembly on board the UAV. For example, as will be explained in greater detail below, the battery arm extends through the opening 112 and unlocks a battery assembly within the UAV. Once unlocked, the battery arm grips the battery assembly and removes the battery assembly from within the UAV. Additionally, in one or more embodiments, the battery arm replaces the removed battery assembly with a new (e.g., charged) battery assembly retrieved from within the UAVGS 102.

In one or more embodiments, rather than having an opening 112 in a wall of the landing housing 110, one or more embodiments of the landing housing 110 include a landing frame or landing housing without a wall that provides unobstructed access between the battery arm and a UAV landed within the UAVGS 102. For example, the landing housing 110 can include a frame structure that includes multiple portions through which the battery arm can extend to engage the UAV and remove a battery assembly from within the UAV.

In one or more embodiments, the UAVGS 102 includes a carousel feature that enables the landing housing 110 and/or UAV to rotate within the UAVGS 102 to align the UAV with respect to one or more battery arms within the UAVGS 102. For example, in one or more embodiments, the landing housing 110 rotates and aligns the opening 112 and/or battery arm with a portion of the UAV that houses the battery assembly such that the battery arm can engage the UAV and remove the battery assembly. As another example, in one or more embodiments, the UAVGS 102 causes the UAV to rotate (e.g., using the floor of the landing housing 110) and align the UAV with the opening 112 in the landing housing 110. Additionally, or alternatively, in one or more embodiments, the UAVGS 102 causes the battery arm to rotate within the UAVGS 102 to align with the opening 112 and the UAV 202.

Furthermore, the UAVGS 102 can include one or more engagement points that secure a UAV in place within the landing housing 110 of the UAVGS 102. In particular, the UAVGS 102 can include one or more components that hold, fasten, or otherwise secure the UAV within the landing housing 110. As an example, the UAVGS 102 can include one or more magnets, grooves, rails, or various mechanical components that secure the UAV in place within the UAVGS 102. Alternatively, in one or more embodiments, the UAV can include one or more components that secure the UAV within the landing housing 110 of the UAVGS 102. The ability to hold the UAV in place within the UAVGS 102 can aid in battery assembly re-movement and replacement as described below.

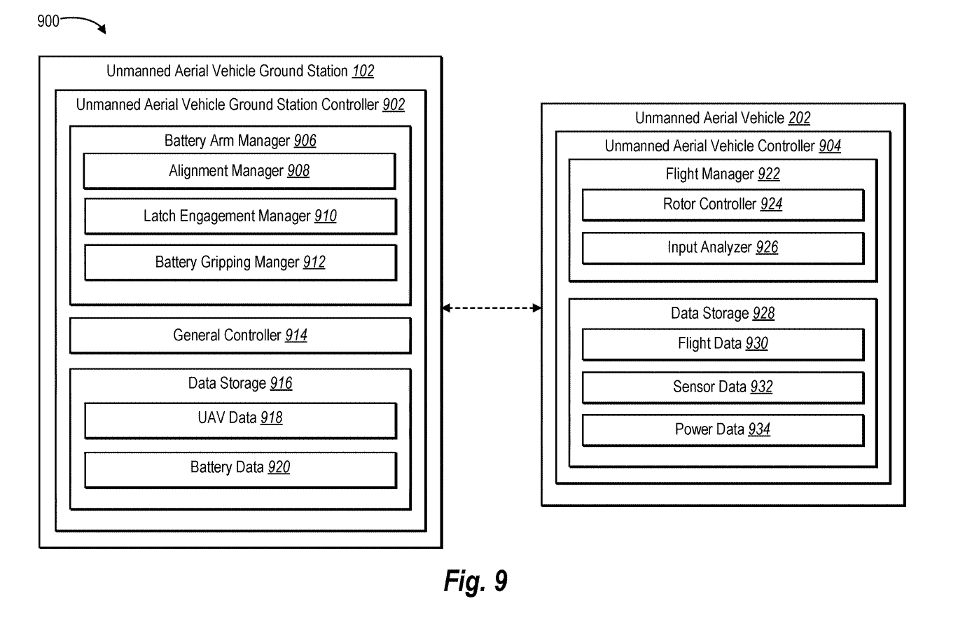

FIG. 2 illustrates an example UAV 202 in accordance with one or more embodiments described herein. As shown, the UAV 202 includes a main body 204 coupled to a plurality of rotor arms 206a-d that each support a respective rotor 208a-d. It will be understood that by varying the speed of the rotors 208a-d, the UAV 202 (e.g., a UAV controller on the UAV 202) can control the speed, direction, and altitude of the UAV 202. For example, the UAV 202 can control the speed of the rotors 208a-d in order to move the UAV 202 within a three-dimensional space. In additional or alternative embodiments, the UAV 202 may include fewer or additional rotor arms and rotors, depending on various factors such as the weight of the UAV 202. Additionally, as discussed above, the UAV 202 can include a computing device, such as described below with reference to FIG. 9, to use for controlling the UAV 202 based on input provided from one or more sensors.

As illustrated in FIG. 2, the UAV 202 includes a landing base 210 coupled to the main body 204 of the UAV 202. In particular, in one or more embodiments, the landing base 210 is connected to and positioned below the main body 204 of the UAV 202. As shown in FIG. 2, the landing base 210 includes a landing frame including legs 212a-d. Each of the legs 212a-d can correspond to respective rotor arms 206a-d. It is appreciated that the landing frame can include any number of legs 212. Alternatively, the landing frame includes a single structure or shell that extends around the landing base 210 (e.g., around a central axis of the UAV 202) and couples a landing pad 214 to the rotors 208 and main housing 204. In one or more embodiments, a shape formed by the legs 212a-d of the landing frame corresponds to the landing housing 110 of the UAVGS 102. For example, the landing frame can form a complimentary conical shape to the conically-shaped landing housing 110 shown in FIG. 1.

Additionally, as shown in FIG. 2, the landing base 210 includes a landing pad 214 positioned below the main body 204 of the UAV 202. In one or more embodiments, the landing pad 214 includes a circular landing ring. For example, the landing pad 214 can include a circular landing ring that corresponds to a shape of the floor of the landing housing 110. Alternatively, the landing pad 214 can include different shapes other than those shown in FIG. 2. For example, the landing pad 214 may have an angular shape, oval shape, or any symmetrical or non-symmetrical shape that fits within the floor of the landing housing.

Additionally, as shown in FIG. 2, the UAV 202 includes a battery assembly 216 within the main body 204 of the UAV 202. For example, as will be described in greater detail below, the battery assembly 216 includes a battery cell within a battery housing that slides in and out of a receiving slot that receives the battery assembly 216 within the main housing 204 of the UAV 202. The battery assembly 216 provides power to any number of systems and components on board the UAV 202. For example, the battery assembly 216 provides power to the rotors 208a-d, a camera attached to the main body 204, and one or more electrical systems on board the UAV 202.

Additionally, as will be explained in greater detail below, the UAV 202 includes one or more latches that secure the battery assembly 216 within the receiving slot of the UAV 202. For example, when the battery assembly 216 is completely inserted within the receiving slot, one or more latches prevent the battery assembly 216 from sliding or falling out of the main housing 204. When removing the battery assembly 216, a battery arm of the UAVGS 102 engages the latches and unlocks the battery assembly. Once the battery assembly 216 is unlocked, the battery arm grips the battery assembly 216 and remove the battery assembly 216 from the receiving slot of the UAV 202. Moreover, as will be explained in greater detail below, the UAV 202 and UAVGS 102 can include a battery swapping assembly that facilitates transfer of a battery assembly 216 between the UAV 202 and UAVGS 102. In particular, one or more embodiments of the UAVGS 102 includes a battery swapping assembly that includes a battery arm and a plurality of battery banks arranged linearly within the housing 104 of the UAVGS 102. Additionally, as will be described in greater detail below, the battery swapping assembly can include an alignment actuator (or simply “actuator”) that causes the battery arm to move within the UAVGS 102. In particular, the actuator can cause the battery arm to align with respect to the UAV 202 and remove a battery assembly 216 from within the UAV 202. Once the battery assembly 216 is removed, the actuator can cause the battery arm to move within the UAVGS 102 and align with respect to one or more battery banks positioned within the UAVGS 102. The battery arm can further insert the battery assembly 216 within one or more of the battery banks and store the battery assembly 216 for later retrieval.

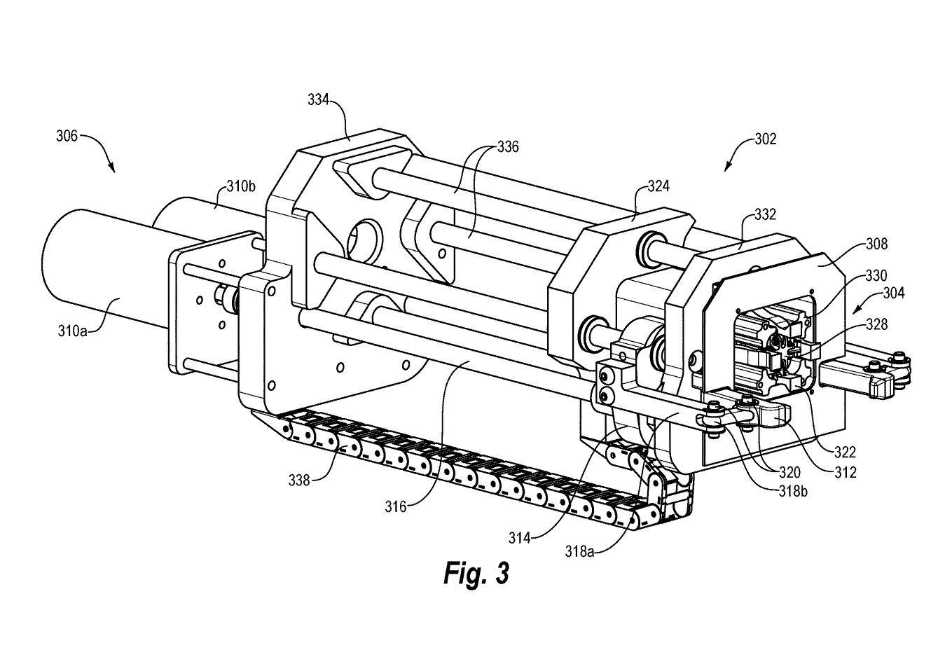

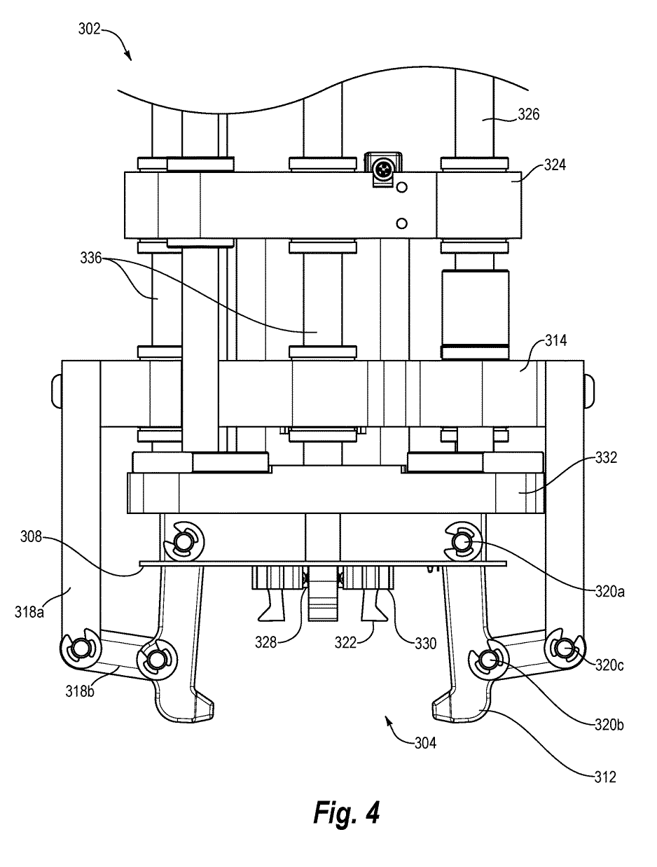

FIGS. 3 and 4 illustrate different views of an example battery arm 302 in accordance with one or more embodiments described herein. As mentioned above, the battery arm 302 can remove and replace a battery assembly 216 from within the main housing 204 of the UAV 202 when the UAV 202 is landed within a UAVGS 102. Prior to removing the battery assembly 216, the battery arm 302 aligns with the battery assembly 216 such that a first end 304 of the battery arm 302 is facing the UAV 202 and a second end 306 of the battery arm 302 is facing outward from the UAV 202 (e.g., toward the housing 104 of the UAVGS 102).

In addition to aligning the battery arm 302 with respect to the UAV 202 and/or battery assembly 216, a portion of the battery arm 302 moves or extends toward the UAV 202. For example, the first end 304 of the battery arm 302 moves toward the UAV 202. In one or more embodiments, the battery arm 302 moves toward the UAV 202 until an end plate 308 or other portion of the first end 304 of the battery arm 302 is within a predefined proximity of the UAV 202 or an end of the battery assembly 216. For example, the UAVGS 102 causes the battery arm 302 to move towards the UAV 202 until the first end 304 of the battery arm 302 is close enough to the UAV 202 that one or more components of the battery arm 302 are able to engage the UAV 202 and/or battery assembly 216.

In one or more embodiments, the battery arm 302 engages one or more latches on a UAV 202 to unlock a battery assembly 216 from within the main housing 204 of the UAV 202. In particular, the battery arm 302 includes a latch engagement assembly that includes one or more actuators that cause one or more latch engagers to come into contact with and engage one or more latches on the UAV 202. For example, as shown in FIG. 3, the latch engagement assembly includes a motor 310a, outer fingers 312, a latch engagement plate 314 (or simply “plate 314”), a driving rod 316, links 318a-b, and one or more pivot points 320 around which portions of the outer fingers 312 rotate. Additionally, FIG. 4 illustrates a view of the first end 304 of the battery arm 302 showing the plate 314, driving rod 316, links 318a-b, pivot points 320, and outer fingers 312.

As mentioned above, the latch engagement assembly can include an actuator, such as a motor 310a. As shown in FIG. 3, the motor 310a is positioned towards the second end 306 of the battery arm 302 and coupled to the outer fingers 312 via a driving rod 316, plate 314, and links 318a-b. While FIG. 3 illustrates one example embodiment of the battery arm 302 that includes a motor 310a, it is appreciated that the battery arm 302 can include various types of actuators such as, for example, hydraulic, pneumatic, electric, magnetic, or mechanical actuators and/or various types of motors capable of causing the outer fingers 312 to move and engage one or more latches on the UAV 202. Additionally, while FIG. 3 illustrates the motor 310a toward the second end 306 of the battery arm 302, it is appreciated that the motor 310a may be located anywhere between the first end 304 and second end 306 of the battery arm 302.

Further, as mentioned above, in causing a battery assembly 216 to unlock from within the UAV 202, the motor 310a causes the outer fingers 312 to rotate and engage with one or more latches on the UAV 202. In particular, the motor 310a can cause the outer fingers 312 to rotate toward the latches on the UAV 202 by driving the plate 314 toward the first end 304 of the battery arm 302 and causing the link 318 between the plate 314 and the outer fingers 312 to move towards the UAV 202. By causing the plate 314 and link 318 to move toward the UAV 202, the outer fingers 312 move about one or more pivot points 320 and rotate inward such that an edge of each of the outer fingers 312 engages with a respective latch on the UAV 202.

In driving the plate 314 towards the first end 304 of the battery arm 302, the motor 310a can cause the driving rod 316 to move and drive the plate 314 towards the UAV 202. In particular, as illustrated in FIG. 3, the driving rod 316 includes a threaded rod that spins and drives the plate 314 by causing the plate 314 to move towards the first end 304 of the battery arm 302 as the threaded driving rod 316 spins. Alternatively, rather than causing a threaded driving rod 316 to spin and drive the plate 314 towards the UAV 202, one or more embodiments of the latch engagement assembly can include a driving rod 316 that extends or otherwise moves to cause the plate 314 to move towards the first end 304 of the battery arm 302 and cause the outer fingers 312 to engage with latches on the UAV 202.

In addition to generally moving the plate 314 and outer fingers 312 towards the UAV 202, driving the plate 314 towards the UAV 202 further causes the outer fingers 312 to rotate about one or more pivot points 320. In particular, as shown in FIGS. 3 and 4, the latch engagement assembly includes a link 318a, 318b between the plate 314 and the outer fingers 312 that couples to the outer fingers 312 via one or more pivot points 320. As will be explained in greater detail below, when the motor 310a drives the plate 314 toward the UAV 202, one or more of the links 318a, 318b also move toward the UAV 202 and cause the outer ends of the outer fingers 312 to move towards the UAV 202 while rotating inward about one or more of the pivot points 320. In particular, when the link 318b moves toward the UAV 202, the movement of the link 318 causes the outer fingers 312 to rotate about one or more pivot points 320 and pivot inward about the first end 304 of the battery arm 302 and engage with latches on the UAV 202. In one or more embodiments, when the outer fingers 312 engage with the latches on the UAV 202, the battery assembly 216 unlocks from within the UAV 202.

In one or more embodiments, the battery gripping assembly utilizes over center linkage features when causing the outer fingers 312 to rotate inward about the one or more pivot points 320a-c. In particular, as shown in FIG. 4, the links 318a, 318b, and the outer finger 312 form an over center linkage. As explained below, the over center linkage can allow for fine tuning of the position of the finger 312 relative to a battery assembly. Additionally, the over center linkage can ensure that the finger 312 does not extend too far toward the battery assembly.

Thus, when the motor 310b causes the plate 314 to move towards the first end 304 of the battery arm 302 and cause the outer fingers 312 to rotate inward relative to the pivot points 320a-c at different rates based on a rotational position of the of the outer fingers 312 with respect to the pivot points 320a-c. For example, the outer fingers 312 can rotate more relative to a corresponding movement of the plate 314 or motor 310b when the outer fingers 312 extend outward from the central axis of the battery arm 302 (e.g., parallel to the outer plate 308) prior to engagement with the UAV 202 or battery assembly 216. Additionally, the outer fingers 312 can rotate less relative to the same movement of the plate 314 or motor 310b when the outer fingers 312 have rotated about the first pivot point 320a and approach an engagement position of the outer fingers 312 (e.g., perpendicular to the outer plate 308).

For example, as shown in FIG. 4, the motor 310b can drive the plate 314 toward the first end 304 of the battery arm 302 which would cause the second pivot point 320b and the third pivot point 320b to initially move toward the first end 304 and cause the outer fingers 312 to rotate about the first pivot point 320a. As the outer fingers 312 continue to rotate about the first pivot point 320a, the second pivot point 320b begins moving inward toward a central axis of the battery arm 302 while the third pivot point 320c continues to move towards the first end 304 of the battery arm 302. As the second pivot point 320b moves towards the central axis of the battery arm, the rate at which the outer fingers rotates about the first pivot point 320a slows relative to movement of the first pivot point 320a towards the first end 304 of the battery arm 302. Thus, as the outer fingers 312 approach an engagement position, the rotation of the outer fingers 312 can slow the rate at which the outer fingers 312 rotate relative to movement of the plate 314 toward the first end 304 of the battery arm 302.

In addition to causing the outer fingers 302 to rotate at different rates relative to movement of the motor 310b or plate 314, the over center linkage can prevent the outer fingers 302 from over-rotating beyond a maximum point of rotation. For example, as the outer fingers 312 rotate about the first pivot point 320a and the second pivot point 320b moves inward toward the central axis of the battery arm 302, the outer fingers 312 reach a maximum rotation about the first pivot point 320a notwithstanding continued movement of the first pivot point 320a toward the first end 304 of the battery arm 302. Thus, the battery arm 302 can drive the plate 314 beyond a point of engagement without causing the outer fingers 312 to continue rotating about the first pivot point 320a and risking damage to the battery assembly 216, UAV 202, or blocking a path for removing or inserting a battery assembly 216 within the UAV 202.

Additionally, or alternatively, in one or more embodiments, the battery arm 302 includes a stop, lock, or other feature that causes the outer fingers to stop rotating inward about the one or more pivot points 320a-c. As an example, the battery arm 302 can include a stop on one or more of the pivot points 320a-c or other portion of the battery arm 302 that prevents the outer fingers 312 from rotating beyond a specific point or angle. Similar to the over center linkage features discussed above, the stop, lock, or other feature the prevents rotation of the outer fingers 312 beyond a maximum rotation can prevent the outer fingers 312 from rotating inward to a point that could potentially damage one or more latches or springs on the UAV 202 or battery assembly 216 or obstruct a path for inserting or removing the battery assembly 216 from within the UAV 202.

Moreover, in one or more embodiments, one or more of the links 318a-b include compression and/or spring properties that cause the outer fingers 312 to apply a constant force to the UAV 202 when engaged with one or more latches on the UAV 202. For example, the first link 318a and/or second link 318b can include a spring that causes the outer fingers 312 to apply a force to one or more latches on the UAV 202 without further force applied via the motors 310b driving the plate 314 toward the UAV 202 beyond initial engagement between the outer fingers 312 and the UAV 202. In one or more embodiments, each of the links 318a-binclude a spring or other compliant member that causes the outer fingers 312 to apply force on respective latches of the UAV 202. Alternatively, in one or more embodiments, only the first link 318a of the first and second links 318a-bincludes a spring or other compliant member that causes the outer fingers 312 to apply force on respective latches of the UAV 202.

In addition to unlocking the battery assembly 216 from within the UAV 202, the battery arm 302 can further remove the battery assembly 216 from the UAV 202. For example, as shown in FIGS. 3-4, the battery arm 302 includes a battery gripping assembly that engages with the battery assembly 216 and grips a portion of the battery assembly 216 while removing the battery assembly 216 from the UAV 202. In particular, as illustrated in FIG. 3, the battery gripping assembly includes a motor 310b, inner fingers 322, a battery gripping plate 324 (or simply “plate 324”), a driving rod 326, a spreader 328, and optionally sensors 330. Additionally, FIG. 4 illustrates a view of the first end 304 of the battery arm 302 showing the inner fingers 322, plate 324, driving rod 326, spreader 328, and sensors 330.

Similar to the latch engagement assembly, the battery gripping assembly includes an actuator, such as a motor 310b. The motor 310b of the battery gripping assembly includes similar features and functionality as the motor 310aof the latch engagement assembly. In one or more embodiments, the motor 310b causes one or more battery grippers to engage a portion of the battery assembly 216 and grip an end of the battery assembly 216. For example, the motor 310b causes inner fingers 322 to engage a portion of the battery assembly 216 and grip the battery assembly 216. In one or more embodiments, the motor 310b causes the ends of the inner fingers 322 to move toward the outer fingers 312 and grip an end of the battery assembly 216. As will be explained in greater detail, once the inner fingers 322 have gripped a portion of the battery assembly 216, the battery arm 302 retracts and removes the unlocked battery assembly 216 from within the UAV 202.

Further, as mentioned above, in causing the inner fingers 322 to engage with and grip the battery assembly 216, the motor 310b drives the plate 324 towards the UAV 202. In particular, similar to the first motor 310a that causes the driving rod 316 to move and drive the latch engagement plate 314 toward the UAV 202, the second motor 310b causes a driving rod 326 to move (e.g., spin, extend) and drive the plate 324 toward the UAV 202. In one or more embodiments, driving the plate 324 toward the UAV 202 causes the inner fingers 322 to pivot outward toward the outer fingers 312 and grip an end of the battery assembly 216.

In one or more embodiments, driving the plate 324 toward the first end 304 of the battery arm 302 causes a spreader 328 to push toward the first end 304 of the battery arm 302 between one or more of the inner fingers 322. In particular, as shown in FIGS. 3-4, the battery gripping assembly includes a spreader 328 positioned between each of the inner fingers 322 and which causes the inner fingers 322 to push, pivot, flex, or otherwise move outward from around a central axis of the battery arm 302 when the plate 324 moves toward the first end 304 of the battery arm 302. For example, when the motor 310b drives the plate 324 toward the UAV 202, the plate 324 can push the spreader 328 toward the first end 304 of the battery arm 302 between each of the inner fingers 322. In one or more embodiments, the spreader 328 causes the inner fingers 322 to flex or bend outward from the central axis of the battery 302 when the plate 324 moves towards the first end of the battery arm 302. Alternatively, the spreader 328 can cause the inner fingers 322 to rotate, pivot, or otherwise move outward from the central axis of the battery arm 302.

Additionally, in one or more embodiments, prior to the inner fingers 322 gripping the battery assembly 216, some or all of the battery gripping assembly can move towards the battery assembly 216. In particular, the plate 324 can cause the inner fingers, spreader 328, and sensors 330 to move towards an outer end of the battery assembly 216 facing outward from the UAV 202. Additionally, in one or more embodiments, the sensors 330 of the battery gripping assembly can detect that the battery gripping assembly or other portion of the battery arm 302 is within a predetermined proximity of the battery assembly 216. For example, the sensors 330 can detect that the battery arm 302 is within a proximity of the battery assembly 216 and prevent the battery gripping assembly from coming into contact with the battery assembly 216 and potentially causing damage to the battery assembly 216 and/of the UAV 202.

In addition to preventing the battery gripping assembly from inadvertently coming into contact with and potentially damaging the UAV 202 and/or battery assembly 216, the sensors 330 can further prevent other portions of the battery gripper 302 from damaging the UAV 202. For example, as described above, the battery arm 302 can move towards the UAV 202 into a position such that the outer fingers 312 can rotate inward around a central axis of the battery arm 302 and engage with corresponding latches on the UAV 202. In one or more embodiments, the sensors 330 can determine that the end plate 308 and/or outer fingers 312 are a particular distance from the UAV 202 that would enable the outer fingers 312 to engage a latch on the UAV 202 and unlock the battery assembly 216 from within the UAV 202. Additionally or alternatively, the sensors 330 can detect when other portions of the battery arm 302 are within a proximity of the UAV 202 that could cause the battery arm 302 to inadvertently come into contact with and potentially damage the UAV 202.

Moreover, as shown in FIG. 3, the battery arm 302 includes one or more additional plates 332, 334 positioned at either end of the battery arm 302. For example, the battery arm 302 includes a first end plate 332 towards the first end 304 of the battery arm 302 and a second end plate 334 towards the second end 306 of the battery arm 302. In one or more embodiments, the first end plate 332 is coupled to the second end plate 334 via one or more guide rails 336. The plates 332, 334 and guide rails 336 provide a horizontal structure along which the plates 314, 324 and driving rods 316, 326 can move and cause portions of the battery arm 302 to engage the UAV 202 and/or battery assembly 216. Additionally, as shown in FIG. 3, the battery arm 302 includes a chain 338 that couples an end plate 334 to a driving plate 324. In one or more embodiments, the chain 338 prevents the driving plate 324 from moving more than a length of the chain 338 away from the end plate 334 and coming into contact with and potentially causing damage to other portions of the battery arm 302 and/or the UAV 202.

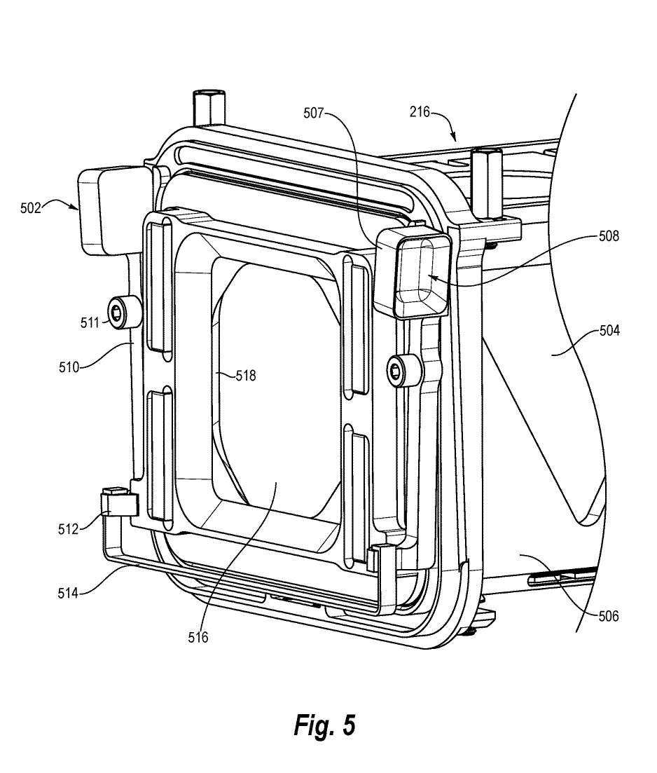

As mentioned above, the battery arm 302 can unlock and remove a battery assembly 216 from within a main housing 204 of a UAV 202. In particular, as shown in FIG. 5, the battery arm 302 can unlock a battery assembly 216 from a UAV 202 by engaging a latch assembly 502 (or simply “latch 502”) on the UAV 202. In particular, in one or more embodiments, the outer fingers 312 of the battery arm 302 can engage a portion of the latch 502 and unlock the battery assembly 216 from within the UAV 202.

As shown in FIG. 5, the battery assembly 216 includes a battery cell 504 within a battery housing 506 inserted and locked within a receiving slot of a UAV 202. In particular, FIG. 5 shows one example of the battery assembly 216 inserted and locked within the main housing 204 of the UAV 202 described above in connection with FIG. 2. Additionally, as shown in FIG. 5, the UAV 202 can include a latch 502 that secures the battery assembly 216 within the receiving slot of the UAV 202. As illustrated in FIG. 5, the latch 506 includes a latch handle 507 (or simply “handle 507”), opening 508 of the handle 507, latch arm 510, pivot 511, lock 512, and latch spring 514. In one or more embodiments, the latch 502 includes an assembly that is part of the main housing 204 of the UAV 202. Alternatively, the latch 502 can include a separate assembly that attaches to or otherwise couples to the main housing 204 of the UAV 202.

As mentioned above, the latch 502 can secure the battery assembly 216 within the UAV 202. In particular, as shown in FIG. 5, a portion of the latch 502 can overlap an opening of the receiving slot of the UAV 202 and prevent the battery assembly 216 from sliding out from the UAV 202. More specifically, in one or more embodiments, the locks 512 of the latch 507 overlap a portion of the opening of the receiving slot thus overlapping a portion of the battery housing 506. As such, where a non-impeded battery assembly 216 would slide out from the UAV 202, the locks 512 provide a structure that prevents the battery assembly 216 from sliding out from the UAV 202 unimpeded.

While the locks 512 provide a structure that prevents the battery assembly 216 from sliding out from the UAV 202 unimpeded, the locks 512 also enable the battery assembly 216 to conveniently slide into the UAV 202 (e.g., without engaging the handles 507). In particular, as shown in FIG. 5 the latch 502 includes a latch spring 514 that connects the locks 512 on either side of the opening to the receiving slot. As such, when outward pressure is applied to the locks 512, the latch spring 514 moves, expands, or otherwise enables the locks 512 to move outward and allow the battery assembly 216 to slide into the opening of the UAV 202.

In one or more embodiments, the locks 512 have a slanted or tapered shape that enables the battery assembly 216 to apply outward force to the locks 512 when the battery assembly 216 slides into the UAV 202. In particular, in one or more embodiments, the locks 512 slant inward such that when the battery assembly 216 makes contact with the locks 512 and moves toward the opening of the UAV 202, an outward force is applied to the locks 512 that causes the latch spring 514 and the locks 512 to move outward. Additionally, once the battery assembly 216 is inserted within the UAV 202, the locks 512 and latch spring 514 automatically return to an equilibrium position with the locks 512 overlapping a portion of the opening of the receiving slot and preventing the battery assembly 216 from sliding out from the UAV 202.

In addition to locking the battery assembly 216 within the UAV 202, the latch 502 can further enable the battery arm 302 to conveniently unlock the battery assembly 216 by engaging the latch handles 507. For example, as shown in FIG. 5, the handles 507 couple to the locks 512 via a latch arm 510 between each handle 507 and lock 512. Additionally, as shown in FIG. 5, the latch 502 includes a pivot 511 around which the latch arm 510 can rotate. As such, when an inward force is applied on each of the latch handles 507, the latch handles 507 move inward around the latch pivot 511 and cause the locks 512 to move outward around the latch pivot 511 until the locks 512 no longer obstruct the receiving slot of the UAV 202. When the locks 512 no longer obstruct the receiving slot of the UAV 202, the battery assembly 216 can slide out from the UAV 202 unobstructed.

In one or more embodiments, the battery arm 302 unlocks the battery assembly 216 by engaging the latch openings 508 of the latch handles 507. In particular, the battery arm 302 can engage the latch openings 508 and apply a force to each of the latch handles 507 that causes the battery assembly 216 to unlock from within the UAV 202. As an example, the outer fingers 312 of the battery arm 302 can fit within the latch openings 508 and push inward on the latch handles 507 causing each of the latch handles 507 to move towards each other (e.g., inward around a central axis of the battery assembly 216). More specifically, the outer fingers 312 can push inward on the latch handles 507 and cause the latch arms 510 to pivot around the latch pivots 511. As the latch handles 507 move inward around the latch pivots 511, the locks 512 move outward from each other (e.g., outward from the central axis of the battery assembly 216) and rotate around the latch pivots 511. As such, by applying the inward force on the latch handles 507, the locks 512 can move outward and remove the obstruction securing the battery assembly 216 in place within the UAV 202.

Once unlocked, the battery arm 302 can further remove the battery assembly 216 from within the UAV 202 by engaging a portion of the battery assembly 216. As shown in FIG. 5, the battery assembly 216 includes an outer end 516 facing outward form the UAV 202. Additionally, as shown in FIG. 5, the outer end 516 of the battery assembly 216 includes an inner lip around one or more edges of the outer end 516. In one or more embodiments, the battery arm 302 can remove the battery assembly 216 by engaging the outer end 516 and one or more inner lips 518 of the outer end 516 of the battery assembly 216.

For example, once the battery assembly 216 is unlocked, a portion of the battery gripping assembly of the battery arm 302 can move towards the outer end 516 and cause a portion of the battery arm 302 to come into contact with the outer end 516. In one or more embodiments, the inner fingers 322 of the battery arm 302 come into contact with the battery end 516. Additionally, upon making contact with or coming within a predetermined proximity to the outer end 516, the inner fingers 322 can engage the inner lip(s) 518 of the outer end 516 and attach, hook, or otherwise grip the battery assembly 216 by the inner lip 518. For example, as described above, when the inner fingers 322 are in position relative to the inner lip 518, the spreader 328 of the battery arm 302 can cause the inner fingers 322 to move outward and grip each of the inner lips 518 of the outer end 516 of the battery assembly 216.

Once the battery arm 302 has gripped the inner lips 518 of the battery assembly 216, the battery arm 302 can retract and cause the battery assembly 216 to slide out from the main housing 204 of the UAV 202. In particular, one or more of the motors 310 of the battery arm 302 can cause one or more portions of the battery arm 302 to retract. For example, in one or more embodiments, the motor 310b coupled to the battery gripping assembly can cause the battery gripping assembly to retract and remove the battery assembly 216 from the UAV 202. Additionally, while the motor 310b causes the battery gripping assembly to retract, the latch engagement assembly (e.g., the outer fingers 312) can remain engaged with the latch 502 and disengage after the battery assembly 216 has been removed from the UAV 202.

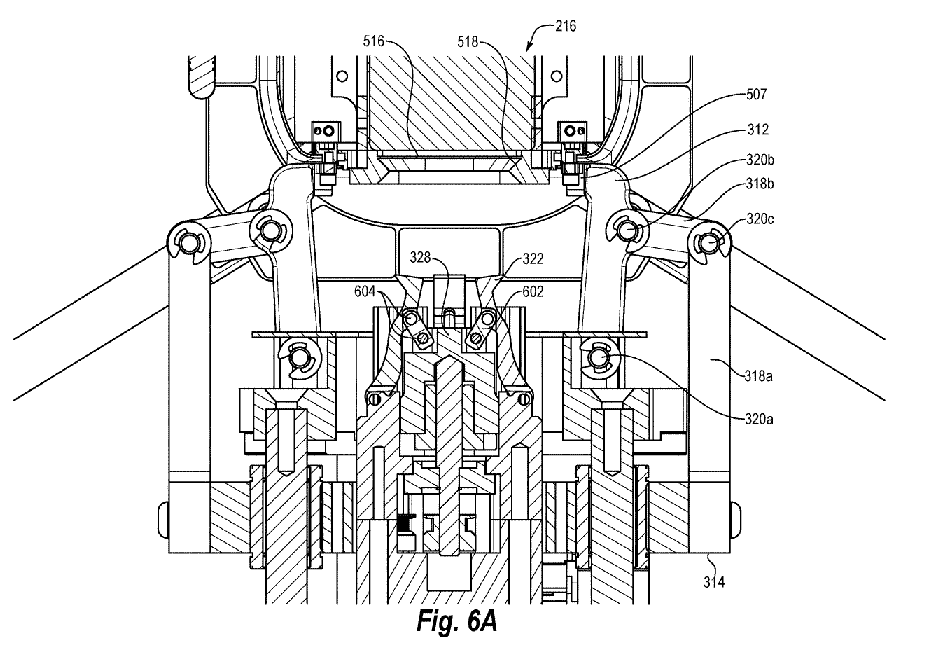

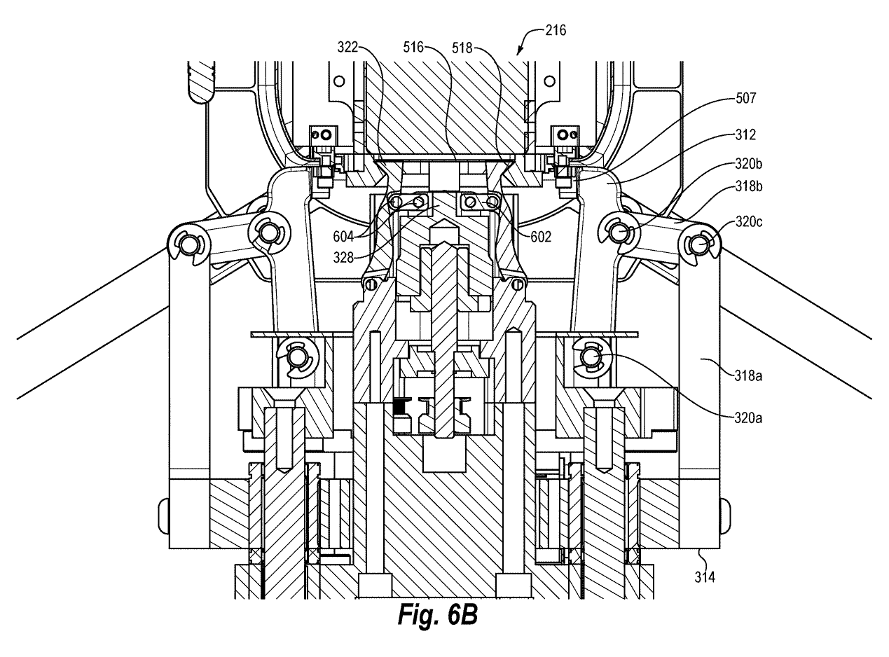

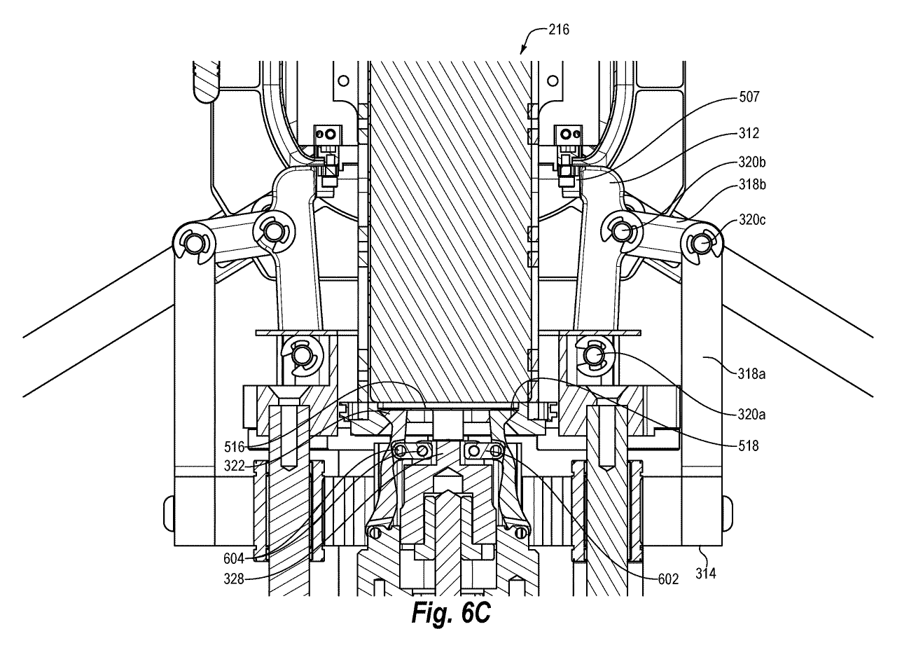

As mentioned above, the battery arm 302 can engage with the UAV 202 to unlock the battery assembly 216 from within the UAV 202. For example, FIG. 6A illustrates an example embodiment of a battery arm 302 unlocking a battery assembly 216 from within the UAV 202. In particular, FIG. 6A shows a top cross-sectional view of one example embodiment in which the latch engagement assembly engages a latch 502 of the UAV 202 to unlock the battery assembly 216 from within the UAV 202.

For example, as shown in FIG. 6A, the outer fingers 312 rotate about a plurality of pivot points 320a-c and engage a handle 507 of the latch 502. In particular, when the drive plate 314 moves towards the UAV 202, the outer fingers 312 rotate about the first pivot point 320a from an initial perpendicular position to the battery assembly 216 to a parallel position relative to the battery assembly 216, as shown in FIG. 6A. While the outer fingers 312 rotate about the first pivot point, a first link 318a between the plate 314 and the outer fingers 312 moves towards the battery assembly 216 causing a second link 318b between the first link 318 and the outer finger 312 to pivot about a second pivot point. Additionally, when the outer fingers 312 approach the handle 507 and fit within the opening 508 of the handle 507, the second link 318b can pivot about the third pivot point 320c as the outer fingers 312 fit within the opening 508 and engage the latch 502.

Additionally, as described above, the outer fingers 312 can unlock the battery assembly 216 from within the UAV 202 by applying inward force on the handles 507 and causing one or more locks 512 to bend, pivot, or otherwise move outward and disengage from a position that prevents the battery assembly 216 from sliding out from the UAV 202. Further, as shown in FIG. 6A, once the outer fingers 312 are engaged, the battery arm 302 incudes a gap between the outer arms 312 that enables an additional portion of the battery arm 302 (e.g., the battery gripping assembly) to move towards the battery assembly 216 between each of the outer arms 312.

As mentioned above, once the battery assembly 216 is unlocked, the battery arm 302 can further engage the battery assembly 216 by gripping a portion of an outer end 516 of the battery assembly 216. For example, as shown in FIG. 6B, the battery gripping assembly can engage the battery assembly 216 by moving towards the battery assembly 216 and coming into contact with the outer end 516. As mentioned above, in one or more embodiments, the battery arm 302 includes one or more sensors 330 that detect that a portion of the battery arm 302 (e.g., the inner fingers 322) have made contact with or are within a threshold proximity of the outer end 516 of the battery assembly 216. As such, the sensors 330 can prevent the battery arm 302 from inadvertently damaging or causing excessive wear and tear on the battery assembly 216 and/or UAV 202.

Once the inner fingers 322 come into contact with the outer end 516, the battery arm 302 can cause the inner fingers 322 to grip an inner lip 518 of the outer end 516 of the battery assembly 216. For example, as shown in FIG. 6B, the battery arm 302 includes a spreader 328 that moves towards the battery assembly 216 and causes the inner fingers 322 to move outward and grip the inner lips 518 of the outer end 516 of the battery assembly 216. In one or more embodiments, the spreader 328 couples to the inner fingers 322 via one or more links 602 that pivot around one or more pivot points 604 as the spreader 328 moves towards the battery assembly 216.

In one or more embodiments, the battery arm 302 can cause a portion of the outer end 516 to compress when the inner fingers 322 or other portion of the battery arm 302 comes into contact with and applies a force on the outer end 516 of the battery assembly 216. For example, after the inner fingers 322 come into contact with the outer end 516 of the battery assembly 216, the outer end 516 can compress into the opening of the receiving port of the UAV 202. When the outer end 516 compresses, the spreader 328 can cause the inner fingers 322 to move outward and grip the inner lips 518 that are made available via the compression of the outer end 516.

While the battery arm 302 grips the unlocked battery assembly 216, the battery arm 302 can retract and remove the battery assembly 216 from the UAV 202. For example, as shown in FIG. 6C, the battery gripping assembly can retract or otherwise move away from the UAV 202 and cause the battery assembly 216 to slide out from the UAV 202. In one or more embodiments, the latch engagement assembly continues to engage the UAV 202 while the battery gripping assembly removes the battery assembly 216 from within the UAV 202. For example, as shown in FIG. 6C, the outer fingers 322 remain engaged with the latch handles 507 to remove the obstruction of the locks 512 while the battery assembly 216 slides out from the UAV 202. The latch engagement assembly can disengage from the latch 502 once the battery assembly 216 is removed and the battery arm 302 can retract within the UAVGS 102.

Additionally, the battery arm 302 can further store the removed battery assembly 216 within the UAVGS 102 and place a new (e.g., charged) battery within the receiving slot of the UAV 202. For example, upon storing the removed battery assembly 216 within the UAVGS 102, the battery arm 302 can move within the UAVGS 102 and retrieve a new battery using a similar or different process as removing the battery assembly 216 from within the UAV 202. The battery arm 302 can further align with the receiving slot of the UAV 202 and insert the new battery within the UAV 202 to enable the UAV 202 to take off, fly, and land with a full battery.

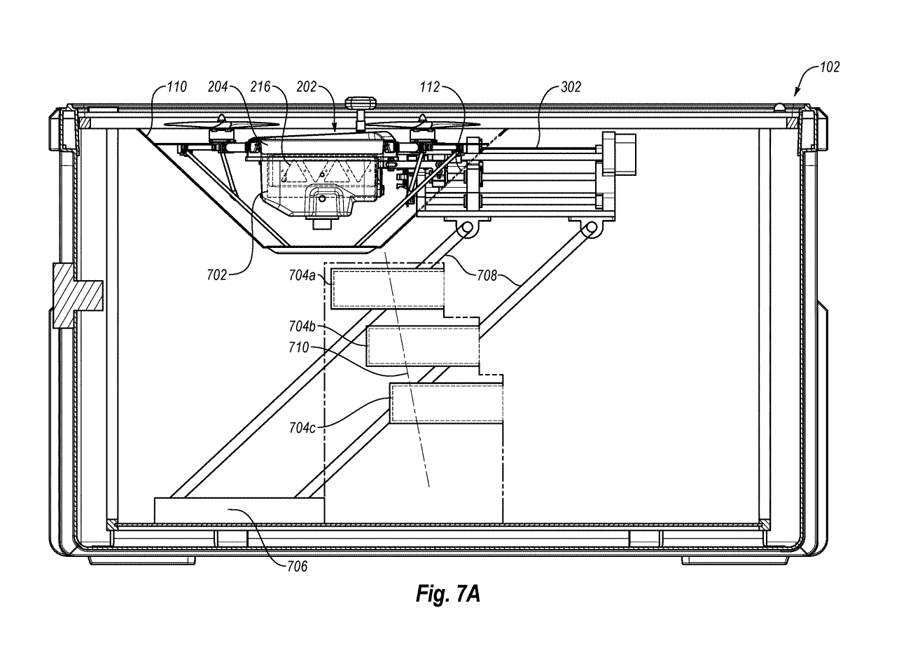

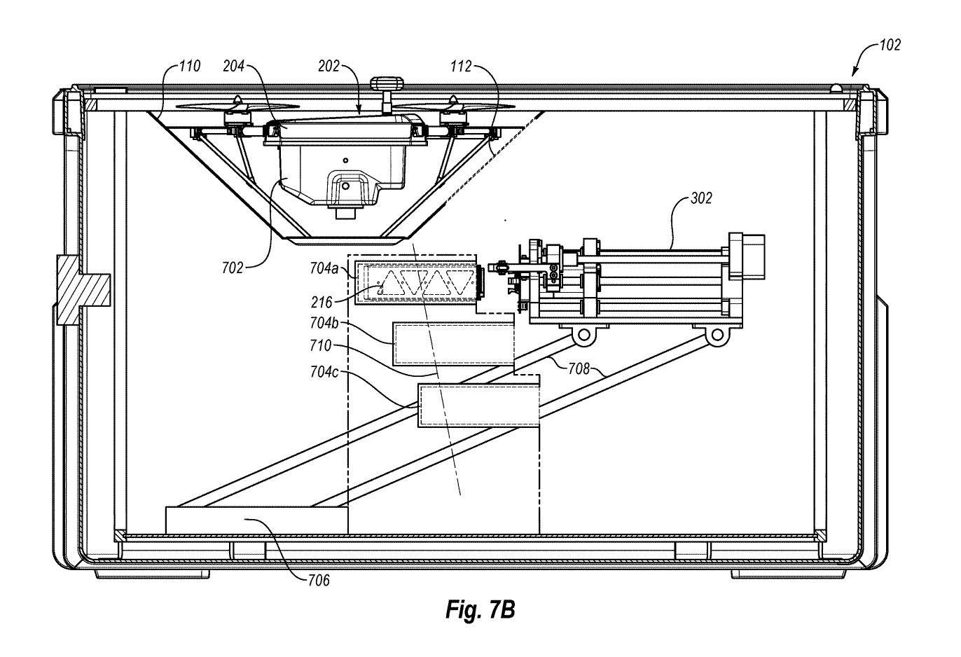

As mentioned above, the UAVGS 102 can include a battery swapping assembly that facilitates transfer of a battery assembly 216 between the UAV 202 and the UAVGS 102. For example, as shown in FIGS. 7A-7B, the battery swapping assembly includes a battery arm 302, a plurality of battery banks 704a-c, a swapping actuator 706 (or simply “actuator 706”), and one or more alignment arms 708 positioned between the battery arm 302 and the actuator 706. Additionally, FIGS. 7A-7B illustrates one embodiment of the battery swapping assembly for removing a battery assembly 216 from within a receiving slot 702 of the UAV 202 and inserting the removed battery assembly 216 within one of the plurality of battery banks 704a-c arranged within the housing 104 of the UAVGS 102.

As shown in FIG. 7A, the UAV 202 can land and align within the landing housing 110 of the UAVGS 102. As shown in FIGS. 7A-7B, the battery swapping assembly includes a plurality of battery banks 704a-c positioned within the UAVGS 102. As used herein, a battery bank can refer to an opening, slot, cavity, or other structure that includes a space sized to receive a battery assembly. For example, the battery banks 704a-c can have a similar size and shape as the receiving slot 702 of the UAV 202. Additionally, in one or more embodiments, one or more of the battery banks 704a-c include similar features and components described above in connection with securing the battery assembly 216 within the main body 204 of the UAV 202. For example, the battery banks 704a-c may include a latch assembly similar to the latch 502 described above in connection with FIG. 5.

Further, as shown in FIG. 7A, the plurality of battery banks 704a-c can have a linear arrangement in accordance with a line 710 that extends through each of the battery banks 704a-c. As used herein, linearly arranged battery banks may refer to various arrangements of battery banks 704a-c that align with respect to a line 710 that passes through each of the battery banks 704a-c. For example, a plurality of linearly arranged battery banks 704a-c can refer to a plurality of battery banks 704a-c that are arranged in a vertical column or horizontal row. Alternatively, as shown in FIGS. 7A-7B, the battery banks 704a-c can have a diagonal arrangement along a line 710 that passes through each of the battery banks 704a-c.

In one or more embodiments, the battery banks 704a-c have a linear arrangement in which each of the plurality of battery banks 704a-c are positioned such that a reference line passes through the same point of the battery banks 704a-c. For example, the battery banks 704a-c may be positioned within the UAVGS 102 such that a reference line 710 passes through a center of mass or other common point (e.g., first or second end) of the battery banks 704a-c. Alternatively, in one or more embodiments, the reference line 710 may pass through each of the battery banks 704a-c at similar or different points of the battery banks 704a-c. As such, the plurality of linearly arranged battery banks 704a-c can refer to a row, column, or diagonal arrangement of battery banks 704a-c that each overlap with each other across a reference line 710 that passes through a portion of each of the plurality of battery banks 704a-c.

As shown in FIGS. 7A-7B, the battery swapping assembly further includes an actuator 706. As shown in FIGS. 7A-7B, the actuator 706 is positioned towards the bottom of the UAVGS 102 and is coupled to the battery arm 302 via one or more alignment arms 708. In one or more embodiments, the actuator 706 includes a motor that causes the battery arm 302 to move within the UAVGS 102. It is appreciated that the actuator 706 may include various types of actuators (e.g., motors), such as, for example, a hydraulic actuator, pneumatic actuator, electric actuator, magnetic actuator, mechanical actuator, or one of various types of motors capable of causing the battery arm 302 to move within the UAVGS 102. Additionally, while FIGS. 7A-7B illustrate the actuator 706 positioned at a base of the UAVGS 102, it is appreciated that the actuator 706 may be located anywhere within the UAVGS 102.

As mentioned above, the actuator 706 can cause the battery arm 302 to move within the UAVGS 102 and align with respect to the UAV 202. In particular, the actuator 706 can cause the alignment arms 708 to move and thereby cause the battery arm 302 to move along an axis of movement within the UAVGS 102. In one or more embodiments, the battery arm 302 moves along a single axis of movement. For example, the actuator 706 can cause the battery arm 302 to move along a rotational axis by rotating the battery arm 302 around a central point. For instance, as shown in FIGS. 7A-7B, the actuator 706 causes the battery arm 302 to rotate about the actuator 706. In one or more alternative embodiments, the actuator 706 causes the battery arm to move along a linear axis. For example, the actuator 706 can cause the battery arm 302 to move vertically, horizontally, or diagonally within the UAVGS 102.

Additionally, while FIGS. 7A-7B illustrate an example battery swapping assembly in which the actuator 706 facilitates movement of the battery arm 302 within the UAVGS 102 by causing the alignment arms 708 to rotate with respect to the actuator 706, one or more embodiments of the battery swapping assembly involve causing the battery arm 302 to move within the UAVGS 102 by causing the alignment arms 708 to retract or extend. For example, the actuator 706 can cause the alignment arms 708 to retract or extend and cause the battery arm 302 to move toward or away from the actuator 706 along a linear axis of movement. Alternatively, the actuator 706 can cause the battery arm 302 to slide along the alignment arms 708 toward or away from the actuator 706 along the linear axis of movement corresponding to the alignment arms 708.

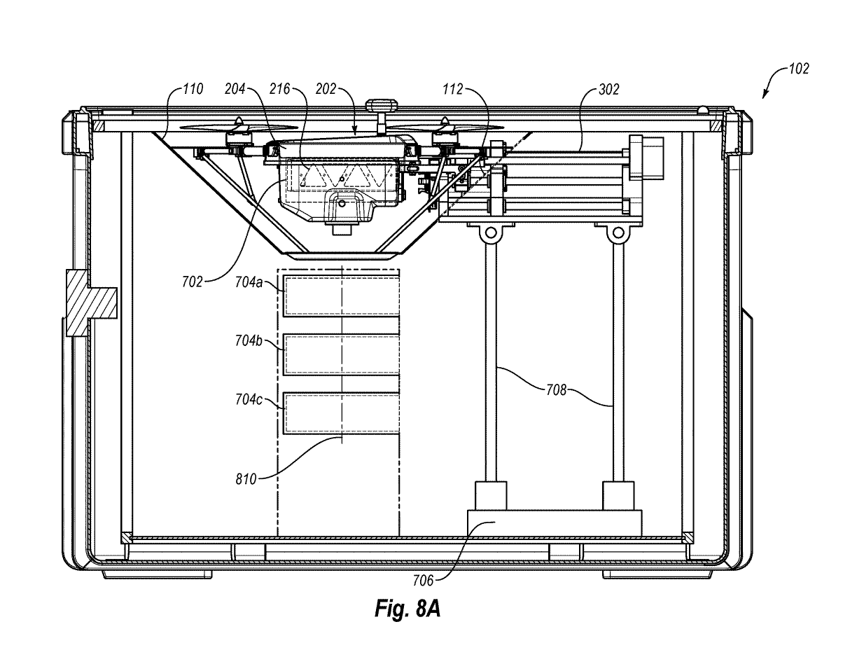

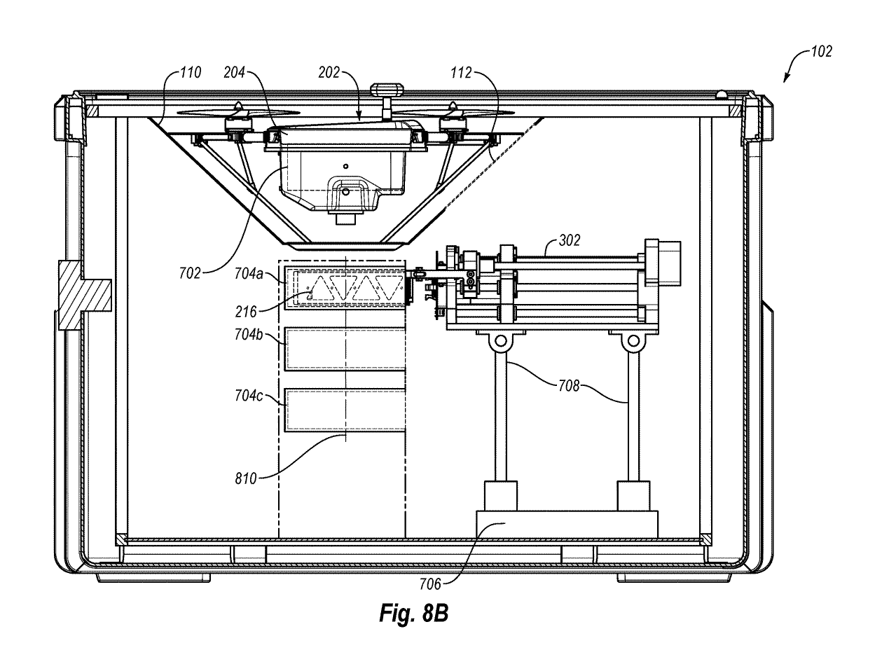

Moreover, while FIGS. 7A-7B illustrate an example battery swapping assembly in which the battery arm 302 moves along a single axis of movement when aligning with respect to the UAV 202, one or more alternative embodiments of the battery swapping assembly can enable the battery arm 302 to move along one or more additional axes of movement. For example, in addition to rotating around a central point about a rotational axis (as shown in FIGS. 7A-7B) or moving vertically along a linear axis (As shown below in FIGS. 8A-8B), one or more embodiments of the UAVGS 102 enable the battery arm 302 to rotate around the landing housing 110 of the UAVGS 102. For example, where the landing housing 110 includes an opening 112 on one side of the UAVGS 102, the actuator 706, carousel feature, or other component within the UAVGS 102 can cause the battery arm 302 to horizontally rotate around the landing housing 110 and align with respect to the receiving slot 702 of the UAV 202.

As mentioned above, the battery swapping assembly can facilitate transfer of a battery assembly 216 from the UAV 202 to the UAVGS 102. For example, as shown in FIG. 7A, the battery swapping assembly aligns the battery arm 302 with the UAV 202. In particular, the actuator 706 can cause the battery arm 302 to rotate around the actuator 706 until an end of the battery arm 302 is aligned with respect to the receiver slot 702 of the UAV 202. As described above, the battery arm 302 can selectively extend through the opening 112 of the landing housing 110 and remove the battery assembly 216 from within the UAV 202.

Once removed, the battery swapping assembly can facilitate storage of the battery assembly 216 within one of the battery banks 704a-c. For example, as shown in FIG. 7B, the actuator 706 can cause the battery arm 302 to rotate downward around the actuator 706 until the end of the battery arm 302 is aligned with a first battery bank 704a of the plurality of batter banks 704a-c. Once aligned, the battery arm 302 can selectively extend toward the first battery bank 704a and insert the battery assembly 216 within the battery bank 704a.

In addition, while not shown in FIGS. 7A-7B, the battery swapping assembly can facilitate transfer of a new (e.g., charged) battery assembly from another battery bank 704 to the UAV 202. For example, the actuator 706 can cause the battery arm 302 to further rotate downward and retrieve a new battery assembly from within a second battery bank 704b or a third battery bank 704c using a similar removal process as removing the battery assembly 216 from the UAV 202 as described above in connection with FIGS. 3-6B Once the new battery is retained, the actuator 706 can cause the battery arm 302 to rotate upward and align with respect to the receiving slot 702 of the UAV 202. The battery arm 302 can then selectively extend through the opening 112 of the landing housing 110 and insert the new battery assembly within the UAV 202.

FIGS. 8A-8B illustrate another example of a battery swapping assembly in which the battery arm 302 moves along a linear axis. In particular, as shown in FIGS. 8A-8B, the battery swapping assembly includes a battery arm 302, a plurality of battery cells 704a-c, an actuator 706, and one or more alignment arms 708 positioned between the battery arm 302 and the actuator 706.

Additionally, as shown in FIGS. 8A-8B, the plurality of battery banks 704a-c can have a vertical arrangement along a reference line 810. In particular, as shown in FIGS. 8A-8B, the battery swapping assembly includes a plurality of battery banks 704a-c positioned on top of each other under the landing housing 110 of the UAVGS 102. Additionally, while FIGS. 8A-8B illustrate one embodiment in which the battery swapping assembly includes three battery banks 704a-c, it is appreciated that the battery swapping assembly can include any number of battery banks 704a-c positioned within the UAVGS 102 and arranged linearly within the UAVGS 102.

Furthermore, as shown in FIGS. 8A-8B, the actuator 706 can cause the battery arm 302 to move vertically and align with respect to the UAV 202 and/or plurality of battery banks 704a-c. As shown in FIGS. 8A-8B, the battery arm 302 moves along a single linear axis of movement. In particular, the actuator 706 causes the battery arm 302 to move vertically along a linear axis parallel to the reference line 810 along which the battery banks 704a-c are located. Alternatively, in one or more embodiments, the battery arm 302 can move along a linear (or non-linear) axis different than the reference line 810 along which the battery banks 704a-c are arranged.

Additionally, as shown in FIGS. 8A-8B, the battery arm 302 can move linearly with respect to one or more alignment arms 708. For example, as shown in FIGS. 8A-8B, the battery arm 302 can move up and down along a path provided by the alignment arms 708. Alternatively, while not shown in FIGS. 8A-8B, one or more embodiments of the alignment arms 708 can extend and retract. As such, the actuator 706 can cause the battery arm 302 to move vertically by causing the alignment arms 708 to expand or retract along the vertical axis.

Moreover, as described above, the battery swapping assembly can facilitate transfer of the battery assembly 216 between the UAV 202 and the plurality of battery banks 704a-c. For example, as shown in FIG. 8A, the actuator 706 causes the battery arm 302 to align with respect to a receiving slot 702 within the main body 204 of the UAV 202. Additionally, as described herein, the battery arm 302 can selectively extend through the opening 112 in the landing housing 110 of the UAVGS 102 and remove the battery assembly 216 from within the UAV 202.

As shown in FIG. 8B, the actuator 706 can cause the battery arm 302 to move vertically within the UAVGS 102 and align with respect to a first battery bank 704a positioned below the landing housing 110 of the UAVGS 102. Once aligned, the battery arm 302 can selectively extend toward the battery bank 704a and insert the battery assembly 216 within the battery bank 704a. In one or more embodiments, the battery bank 704a can include a latch 502 or other similar locking mechanism as described herein that secures the battery assembly 216 within the battery bank 704a.

Additionally, similar to one or more embodiments described above, the battery swapping assembly can facilitate retrieving a new (e.g., charged) battery assembly and inserting the new battery assembly within the UAV 202. In particular, the actuator 706 can cause the battery arm 302 to align with respect to the second battery bank 704b and remove a new battery assembly previously stored within the second battery bank 704b. The actuator 706 can then cause the battery arm 302 to move upward and align with respect to the UAV 202 and insert the new battery assembly within the receiving slot 702 of the UAV 202.

Additionally, one or more embodiments of the plurality of battery banks 704a-c include a charging interface that couples to a battery assembly 216 when the battery assembly 216 is inserted within one of the plurality of battery banks 704a-c. For example, one or more of the battery banks 704 can include one or more charging contacts within an inner portion of the battery banks 704 that couple to corresponding contacts on the battery assembly 216 when the battery assembly 216 is inserted within the battery banks 704. Once the battery assembly 216 is inserted, the UAVGS 102 can provide a power signal across the charging contacts that charges a battery cell within the battery assembly 216.

As such, the battery swapping assembly can charge the battery assembly in preparation for later retrieval and use. While the UAV 202 engages in another flight, the battery swapping assembly can charge the battery assembly 216 in preparation for replacing the battery assembly 216 currently inserted within the UAV 202. The battery swapping assembly can thus enable convenient swapping of battery assemblies between back to back flights to enable the UAV 202 engage in frequent flights with a full battery. Additionally, the battery swapping assembly can enable the UAV 202 to engage in frequent flights without storing a large number of battery assemblies within the UAVGS 102.

FIG. 9 illustrates a schematic diagram showing an example embodiment of an autonomous landing system 900 (or simply “system 900”) within which various embodiments of battery swapping assemblies may be implemented. As shown in FIG. 9, the system 900 may include various components for performing the processes and features described herein. For example, as shown in FIG. 9, the system 900 includes, but is not limited to, an unmanned aerial vehicle ground station 102 (or simply “UAVGS 102”) and an unmanned aerial vehicle 202 (or simply “UAV 202”). As shown in FIG. 9, the UAVGS 102 can include a UAVGS controller 902, which in turn can include, but is not limited to, a battery arm manager 906 including an alignment manager 908, latch engagement manager 910, and a battery gripping manager 912. Additionally, the UAVGS controller 902 can include a general controller 914 and data storage 916 including UAV data 918 and battery date 920. Further, as shown in FIG. 9, the UAV controller 904 can include, but it not limited to, a flight manager 922 including a rotor controller 924 and an input analyzer 926. Additionally, the UAV controller 904 can include a data storage 928 including flight data 930, sensor data 932, and power data 934.

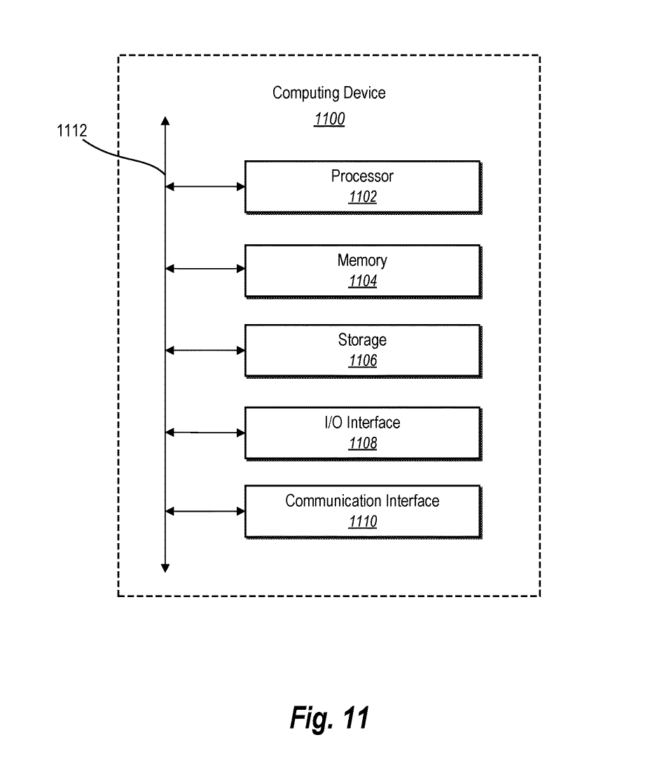

Each of the components 906-920 of the UAVGS controller 902, and the components 922-934 of the UAV controller 904 can be implemented using a computing device including at least one processor executing instructions that cause the system 900 to perform the processes described herein. In some embodiments, the components 906-920 and 922-934 can comprise hardware, such as a special-purpose processing device to perform a certain function. Additionally or alternatively, the components 906-920 and 922-934 can comprise a combination of computer-executable instructions and hardware. For instance, in one or more embodiments the UAV 202 and/or the UAVGS 102 include one or more computing devices, such as the computing device described below with reference to FIG. 11. In one or more embodiments, the UAVGS controller 902 and the UAV controller 904 can be native applications installed on the UAVGS 102 and the UAV 202, respectively. In some embodiments, the UAVGS controller 902 and the UAV controller 904 can be remotely accessible over a wireless network.

Additionally, while FIG. 9 illustrates a UAVGS controller 902 having components 906-920 located thereon, it is appreciated that the UAV controller 904 can include similar components having features and functionality described herein with regard to the UAVGS controller 902. Similarly, while FIG. 9 illustrates a UAV controller 904 having components 922-934 located thereon, it is appreciated that the UAVGS controller 902 can include similar components having features and functionality described herein with regard to the UAV controller 904. As such, one or more features described herein with regard to the UAVGS controller 902 or the UAV controller 904 can similarly apply to both the UAVGS controller 902 and/or the UAV controller 904.

As described above, the system 900 includes components across both the UAVGS 102 and the UAV 202 that enable the UAV 202 to autonomously land on the UAVGS 102 and for the UAVGS 102 to replace a battery on board the UAV 202. Accordingly, the system 900 includes various components that enable a battery swapping assembly on board the UAVGS 102 to transfer a battery assembly 216 between the UAV 202 and the UAVGS 102 while the UAV 202 is landed without any external intervention (e.g., without an operator remotely controlling the UAVGS 102 and/or UAV 202 during the battery removal process). Additionally, in one or more embodiments, the UAVGS 102 can cause a battery arm 302 to perform a multi-stage engagement process with respect to removing the battery assembly 216 and/or storing the battery assembly 216 on board the UAVGS 102 autonomously without assistance from a remote operator and without causing substantial wear and tear on the UAV 202.

As mentioned above and as illustrated in FIG. 9, the UAVGS controller 902 includes a battery arm manager 906 that controls various functions of a battery arm 302 on board the UAVGS 102. As shown in FIG. 9, the battery arm manager 906 includes an alignment manager 908 that controls a position of the battery arm 302 with respect to a landed UAV 202. For example, the alignment manager 908 can cause the battery arm 302 to rotate, shift, or otherwise move within a housing 104 of the UAVGS 102 such that an end of the battery arm 302 aligns with respect to the battery assembly 216 within the UAV 202.

For example, the alignment manager 708 can cause a battery arm 302 to align with respect to the UAV 202 that is landed within the UAVGS 102. In particular, the alignment manager 908 can cause the battery arm 302 to move along an axis of movement and align with respect to an end of a battery assembly 216 inserted within a receiving slot 702 of the UAV 202. Additionally, once the battery assembly 216 is removed, the alignment manager 908 can cause the battery arm 302 to move along the axis of movement and align with respect to a plurality of battery banks 704 within the UAVGS 102. The alignment manager 908 can further cause the battery 302 to move back and forth between the UAV 202 and the plurality of battery banks 704 to facilitate swapping one or more battery assemblies back and forth between the UAV 202 and the UAVGS 102.

In addition or as an alternative to causing the battery arm 302 to move within the UAVGS 102 with respect to the UAV 202, one or more embodiments of the alignment manager 908 cause one or more components of the UAVGS 102 and/or UAV 202 to move with respect to the battery arm 302. For example, in one or more embodiments, the alignment manager 908 controls movement of a landing housing 110 of the UAVGS 102 and causes a floor of the landing housing 110 and/or an opening 112 of the landing housing 110 to rotate such that a receiving slot of the UAV 202 lines up with the battery arm 302. Additionally, in one or more embodiments, the alignment manager 908 can control movement of the battery arm 302, landing housing 110, floor of the landing housing 110, and/or the UAV 202 based on one or more sensor inputs from sensors on the UAVGS 102 (e.g., on the battery arm 302 of the UAVGS 102) and/or UAV 202.

In addition to the alignment manager 908, the battery arm manager 906 includes a latch engagement manager 910 that controls engagement of the UAV 202 using a portion of the battery arm 302. For example, once the battery arm 302 is aligned with respect to the UAV 202, the latch engagement manager 910 can cause a latch engagement assembly of the battery arm 302 to move towards the UAV 202 and engage one or more latches of the UAV 202. Additionally, engaging the UAV 202 can cause the battery assembly 216 within the UAV 202 to unlock such that the battery assembly 216 can slide out from a receiving slot of the UAV 202.

In one or more embodiments, the latch engagement manager 910 causes the battery assembly 216 to unlock by applying a force on one or more latch handles 507 and removing one or more obstructions (e.g., latch locks 512) that prevent the battery assembly 216 to slide out from the UAV 202. For example, the latch engagement manager 910 can cause outer fingers 312 to rotate around one or more pivot points, engage the latch handles 507, and unlock the battery assembly 216 from within the UAV 202.

As shown in FIG. 9, the battery arm manager 906 further includes a battery gripping manager 912 that causes the battery arm 302 to grip a portion of the battery assembly 216 and/or UAV 202 and remove the unlocked battery assembly 216 from the UAV 202. For example, the battery gripping manager 914 can control movement of one or more inner fingers 322 that grip an outer end 516 of the battery assembly 216. Additionally, the battery gripping manager 914 can cause a portion of the battery arm 302 to retract and remove the battery assembly 216 from within the UAV 202.

Moreover, while not shown in FIG. 9, the battery arm manager 906 can further control movement of the battery arm 302 to store a removed battery assembly 216 and/or replace the removed battery assembly 216 with a new (e.g., charged) battery. For example, the battery arm manager 906 can cause the battery arm 302 to rotate and/or move within the UAVGS 102 and place the removed battery assembly 216 within a charging slot within the UAVGS 102. Additionally, in one or more embodiments, the battery arm manager 906 can cause the battery arm 302 to grip a new battery and place the new battery within the UAV 202.

In addition to the battery arm manager 906, the UAVGS controller 902 further includes a general controller 914. In one or more embodiments, the general controller 914 can handle general system tasks including, for example, battery charging, data storage, UAV docking, receiving and processing user input, etc. As an example, after the UAV 202 autonomously lands on the UAVGS 102, the general controller 914 can manage receiving and processing user input with regard to recharging a battery while the UAV 202 is landed. As another example, in one or more embodiments, the general controller 914 can manage downloading or transferring data collected by the UAV 202 (e.g., during a previous flight). Additionally, in one or more embodiments, the general controller 914 can control transmission, receiving, and processing various signals received from the UAV 202.

Furthermore, as mentioned above, and as illustrated in FIG. 7, the UAVGS controller 902 also includes a data storage 916. As shown, the data storage 916 can include UAV data 918 and battery data 920. In particular, the UAV data can include data representative of information associated with the UAV 202. Additionally, the battery data 920 can include information associated with batteries within the UAV 202 and/or within the UAVGS 102. For example, the battery data 920 can include information about battery life, charge capacity, voltage and current specifications and other information associated with batteries within the UAV 202 and/or UAVGS 102.

As shown in FIG. 9, the UAV controller 904 includes a flight manager 922. In one or more embodiments, and in order for the UAV 202 to autonomously land on the UAVGS 102, the flight manager 922 can control all of the mechanical flight elements associated with the UAV 202 (e.g., motors, rotor arms, rotors, landing gear, etc.). For example, in at least one embodiment, the flight manager 922 can receive input from one or more sensors on the UAV 202 and/or UAVGS 102. The flight manager 922 can then control various mechanical features of the UAV 202 based on the received inputs in order to autonomously land the UAV 202 on the UAVGS 102.

As illustrated in FIG. 9, the flight manager 922 includes a rotor controller 924. In one or more embodiments, the rotor controller 924 controls the speed of one or more rotors associated with the UAV 202. Accordingly, by controlling the speed of the rotors, the rotor controller 924 can cause the UAV 202 to travel up and down vertically. Additionally, in at least one embodiment, the rotor controller 924 controls the pitch of one or more rotors associated with the UAV 202. Further, by controlling the speed of the rotors, the rotor controller 924 can cause the UAV 202 to travel back and forth, and side to side horizontally. Thus it follows that, by controlling the speed of one or more rotors associated with the UAV 202, the rotor controller 924 can cause the UAV 202 to travel anywhere within an uninhibited three-dimensional space.

Also as illustrated in FIG. 9, the flight manager 922 includes an input analyzer 926. In one or more embodiments, the input analyzer 926 analyzes the data or inputs received in order to determine a position of the UAV 202. For example, in one embodiment, the input analyzer 926 can analyze digital photographs or video provided by a camera on the UAV 202 to determine whether the UAV 202 is located in a position above the UAVGS 102. In another example, the input analyzer 926 can analyze energy sensor readings of an energy wave to determine how far above the UAVGS 102 the UAV 202 is located (e.g., the altitude of the UAV 202). The input analyzer 926 can utilize algorithms, lookup tables, etc. in order to determine the UAV's 202 position based on inputs received from the UAVGS 102 and/or other components within the UAV 202. Additionally, in at least embodiment, the input analyzer 926 can receive inputs from a global position system associated with the UAV 202 in order to determine the UAV's 202 position.

Furthermore, as mentioned above, and as illustrated in FIG. 9, the UAV controller 904 also includes a data storage 928. As shown, the data storage 928 can include flight data 930 and sensor data 932. In one or more embodiments, the flight data 930 can include data representative of the UAV's 202 flight, such as described herein (e.g., GPS information, camera information, etc.). Similarly, in one or more embodiments, the sensor data 932 can include data representative of information gathered by one or more sensors located on the UAV 202 and/or UAVGS 102. Additionally, in one or more embodiments, the data storage 928 can include power data 934. The power data 934 can include data representative of power information associated with a battery and/or one or more power systems on board the UAV 202. For example, the power data 934 can include a battery level, a remaining life of a battery, or a time for the battery on board the UAV 202 to recharge when docked within the UAVGS 102.

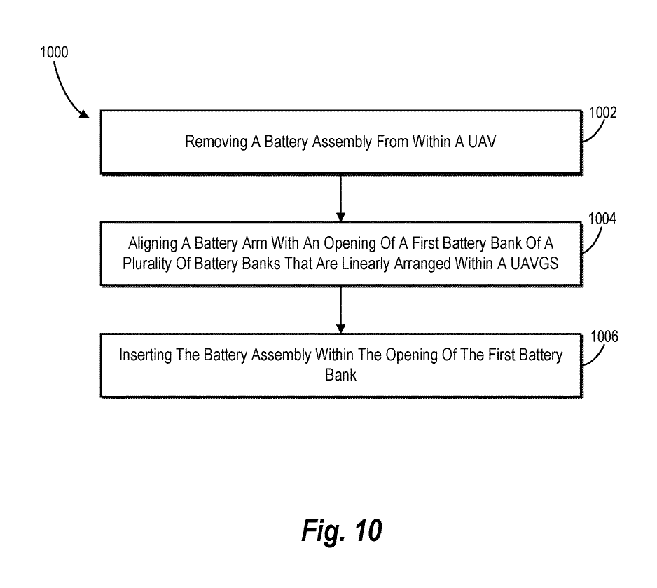

FIGS. 1-9, the corresponding text, and the above-discussed examples provide a number of different methods, systems, and devices for replacing a battery assembly 216 from within a UAV 202. In addition to the foregoing, embodiments can also be described in terms of flowcharts comprising acts and steps in a method for accomplishing a particular result. For example, the method of FIG. 10 may be performed with less or more steps/acts or the steps/acts may be performed in differing orders. Additionally, the steps/acts described herein may be repeated or performed in parallel with one another or in parallel with different instances of the same or similar steps/acts.

FIG. 10 illustrates a flowchart of one example method 1000. For example, the method 1000 can include a method of swapping a battery assembly 216 between an unmanned aerial vehicle (UAV) 202 and an unmanned aerial vehicle ground station (UAVGS) 102. In one or more embodiments, each step of the method 1000 is performed by a battery swapping assembly within a UAVGS 102 that includes a battery arm 302. Additionally or alternatively, the UAV 202 can perform one or more steps of the method 1000. In one or more embodiments, the UAVGS 102 and/or UAV 202 performs one or more steps in accordance with computer-executable instructions and hardware installed on the UAVGS 102 and/or UAV 202.

As shown in FIG. 10, the method 1000 includes a process for swapping a battery assembly 216 between a UAV 202 and a UAVGS 102. For example, as shown in FIG. 10, the method 1000 includes a step 1002 of removing a battery assembly 216 from within a UAV 202. In one or more embodiments, removing the battery assembly 216 from within the UAV 202 involves causing a battery arm 302 to engage with the UAV 202 and/or first end (e.g., outer end 516) of the battery assembly 216. For example, removing the battery assembly 216 can involve gripping the outer end 516 of the battery assembly 216. Additionally, removing the battery assembly from within the UAV 202 can involve retracting the battery arm 302 (or portion of the battery arm 302) from the UAV while gripping the outer end 516 of the battery assembly 216.

Additionally, as shown in FIG. 10, the method 1000 further includes an act 1004 of aligning the battery arm 302 with an opening of a first battery bank of a plurality of battery banks 704 that are linearly arranged within a UAVGS 102. In one or more embodiments, aligning the battery arm 302 with the opening of the first battery bank involves causing the battery arm 302 to move along an axis of movement within the UAVGS 102. For example, aligning the battery arm with the opening of the first battery bank can involve causing the battery arm 302 to move along a rotational, linear, or other type of axis of movement within the UAVGS 102. In one or more embodiments, aligning the battery arm 302 with the opening of the first battery bank involves causing the battery arm 302 to move along a single axis of movement. Alternatively, aligning the battery arm 302 with the opening of the first battery bank can involve causing the battery arm 302 to move along multiple axes of movement.

Further, as shown in FIG. 10, the method 1000 includes an act 1006 of inserting the battery assembly 216 within the opening of the first battery bank. In one or more embodiments, inserting the battery assembly 216 within the first battery bank involves causing the battery arm 302 to selectively extend towards the first battery bank while the battery arm 302 grips the first end (e.g., outer end 516) of the battery assembly 216. As an example, inserting the battery assembly 216 within the first battery bank can involve causing the battery swapping assembly of the battery arm 302 to extend towards the first battery bank. Further, inserting the battery assembly 216 within the first battery bank can involve causing the battery swapping assembly of the battery arm 302 to release a grip on the outer end 516 of the battery assembly 216 once the battery assembly 216 is inserted within the first battery bank. Additionally, while the method 1000 includes one or more steps for swapping the battery assembly 216 between the UAV 202 and a first battery bank of a plurality of battery banks, it is appreciated that one or more alternative embodiments of the method 1000 can involve swapping the battery assembly 216 between the UAV 202 and any one of the plurality of battery banks 704 linearly arranged within the UAVGS 102.

Additionally, while not shown in FIG. 10, the method 1000 can further include an act of charging the battery assembly 216. In particular, the method 1000 can involve a step of charging the battery assembly 216 while the battery assembly 216 is inserted within the first battery bank. For example, when the battery assembly 216 is inserted within the first battery bank, one or more contacts on the battery assembly 216 can electrically couple to one or more corresponding charging contacts within the first battery bank. While the battery assembly 216 is inserted within the first battery bank, the UAVGS 102 can provide a power signal via the charging contacts that charges a battery cell of the battery assembly 216.

Additionally, in one or more embodiments, the method 1000 includes one or more steps for replacing the battery assembly 216 with a replacement battery assembly stored within a second battery bank of the plurality of battery banks. For example, the method 1000 can include a step of aligning the battery arm 302 with an opening of a second battery bank having a replacement battery assembly stored therein by causing the battery arm 302 to move along the axis of movement. Additionally, the method 1000 can further include removing the replacement battery from within the second battery bank by causing the battery arm 302 to grip a first end of the replacement battery assembly and retract from the second battery bank. The method 1000 can further include aligning the battery arm 302 with the UAV 202 by causing the battery arm 302 to move along the axis of movement towards the UAV 202. The method 1000 can further include inserting the replacement battery assembly within the UAV 202 by causing the battery arm 302 to selectively extend towards the UAV 202 while the battery arm 302 grips the first end of the replacement battery assembly.

Further, in one or more embodiments, the method 800 includes receiving a user input instructing the UAVGS 102 and/or battery arm 302 to perform one or more of the steps of the method 1000. Additionally or alternatively, the method 1000 may include receiving an input that indicates that the battery assembly 216 should be replaced and performing each of the steps 1000 of the method in response to receiving the input.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) could be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, watches, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 11 illustrates a block diagram of exemplary computing device 1100 that may be configured to perform one or more of the processes described above (e.g., as described in connection with the UAV 202 or UAVGS 102). As an example, the exemplary computing device 1100 can be configured to perform a process for removing and/or replacing a battery assembly 216 within a UAV 202. Further, the exemplary computing device 100 can be configured to store one or more battery assemblies 216 in linearly arranged battery banks 704 within the UAVGS 102. Additionally, the computing device 1100 can be configured to perform one or more steps of the method 800 described above in connection with FIG. 8. As shown by FIG. 11, the computing device 1100 can comprise a processor 1102, a memory 1104, a storage device 1106, an I/O interface 1108, and a communication interface 1110, which may be communicatively coupled by way of a communication infrastructure 1112. While an exemplary computing device 1100 is shown in FIG. 11, the components illustrated in FIG. 11 are not intended to be limiting. Additional or alternative components may be used in other embodiments. Furthermore, in certain embodiments, the computing device 1100 can include fewer components than those shown in FIG. 11. Components of the computing device 1100 shown in FIG. 11 will now be described in additional detail.

In one or more embodiments, the processor 1102 includes hardware for executing instructions, such as those making up a computer program. As an example and not by way of limitation, to execute instructions, the processor 1102 may retrieve (or fetch) the instructions from an internal register, an internal cache, the memory 1104, or the storage device 1106 and decode and execute them. In one or more embodiments, the processor 1102 may include one or more internal caches for data, instructions, or addresses. As an example and not by way of limitation, the processor 1102 may include one or more instruction caches, one or more data caches, and one or more translation lookaside buffers (TLBs). Instructions in the instruction caches may be copies of instructions in the memory 1104 or the storage 1106.

The memory 1104 may be used for storing data, metadata, and programs for execution by the processor(s). The memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1104 may be internal or distributed memory.

The storage device 1106 includes storage for storing data or instructions. As an example and not by way of limitation, storage device 1106 can comprise a non-transitory storage medium described above. The storage device 1106 may include a hard disk drive (“HDD”), a floppy disk drive, flash memory, an optical disc, a magneto-optical disc, magnetic tape, or a Universal Serial Bus (“USB”) drive or a combination of two or more of these. The storage device 1106 may include removable or non-removable (or fixed) media, where appropriate. The storage device 1106 may be internal or external to the computing device 1100. In one or more embodiments, the storage device 1106 is non-volatile, solid-state memory. In other embodiments, the storage device 1106 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 1108 allows a user to provide input to, receive output from, and otherwise transfer data to and receive data from computing device 1100. The I/O interface 1108 may include a mouse, a keypad or a keyboard, a touch screen, a camera, an optical scanner, network interface, modem, other known I/O devices or a combination of such I/O interfaces. The I/O interface 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1108 is configured to provide graphical data to a display for presentation to a user. The graphical data may be representative of one or more graphical user interfaces and/or any other graphical content as may serve a particular implementation.

The communication interface 1110 can include hardware, software, or both. In any event, the communication interface 1110 can provide one or more interfaces for communication (such as, for example, packet-based communication) between the computing device 1100 and one or more other computing devices or networks. As an example and not by way of limitation, the communication interface 1110 may include a network interface controller (“NIC”) or network adapter for communicating with an Ethernet or other wire-based network or a wireless NIC (“WNIC”) or wireless adapter for communicating with a wireless network, such as a WI-FI.

Additionally or alternatively, the communication interface 1110 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 1110 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 1110 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 1112 may include hardware, software, or both that couples components of the computing device 1100 to each other. As an example and not by way of limitation, the communication infrastructure 1112 may include a graphics bus, front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Peripheral Component Interconnect (“PCI”) bus, a PCI-Express (“PCIe”) bus, a serial advanced technology attachment (“SATA”) bus, or another suitable bus or a combination thereof.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A system comprising:
an unmanned aerial vehicle (UAV) comprising:
a main body; and
a battery assembly within the main body of the UAV; and
an unmanned aerial vehicle ground station (UAVGS) comprising:
a landing housing sized and configured to receive the UAV when the UAV lands within the UAVGS; and
a battery swapping assembly comprising:
a battery arm operable to extend through the landing housing to engage the battery assembly and remove the battery assembly from within the UAV;
a plurality of battery banks linearly arranged within the UAVGS and sized to receive the battery assembly; and
an alignment assembly, the alignment assembly comprising an actuator that causes the battery arm to move along a first axis and align with respect to the plurality of linearly arranged battery banks to allow the battery arm to insert the battery assembly within the plurality of linearly arranged battery banks.

2. The system as recited in claim 1, wherein the plurality of battery banks comprises one or more charging contacts corresponding to one or more battery contacts on an end of the battery assembly, wherein the one or more charging contacts are positioned so as to couple to the one or more battery contacts when the battery assembly is inserted within the plurality of battery banks.

3. The system as recited in claim 2, wherein the charging contacts provide a charging signal that charges the battery assembly when the battery assembly is inserted within the plurality of battery banks.

4. The system as recited in claim 1, wherein the plurality of battery banks comprise a latch that secures the battery assembly within the plurality of battery banks when the battery assembly is inserted within the plurality of battery banks.

5. The system as recited in claim 4, wherein the battery arm comprises a latch engagement assembly sized to engage the latch and allow the battery arm to unlock the battery assembly from within the plurality of battery banks.

6. The system as recited in claim 1, wherein the battery arm comprises one or more proximity sensors that detects a distance between an end of the battery arm and the battery assembly when the battery assembly is within the plurality of battery banks.

7. The system as recited in claim 1, wherein the landing housing comprises an opening having a position along the first axis with respect to the plurality of linearly arranged battery banks.

8. A battery swapping assembly, comprising:
a battery arm operable to extend into an unmanned aerial vehicle ground station (UAVGS) to grip a battery assembly within an unmanned aerial vehicle (UAV) and retract the battery assembly from the UAV while gripping the battery assembly;
a plurality of battery banks linearly arranged within the UAVGS, the battery banks sized to receive the battery assembly; and
an alignment assembly coupled to the battery arm, the alignment assembly comprising an actuator that causes the battery arm to move along a first axis and align a first end of the battery arm with respect to the plurality of linearly arranged battery banks to allow the battery arm to insert the battery assembly within the plurality of linearly arranged battery banks

9. The battery swapping assembly as recited in claim 8, wherein the first axis is a rotational axis.

10. The battery swapping assembly as recited in claim 9, wherein the actuator causes the battery arm to rotate with respect to the actuator along the rotational axis.

11. The battery swapping assembly as recited in claim 9, wherein the first axis is a linear axis.

12. The battery swapping assembly as recited in claim 11, wherein the actuator causes the battery arm to move linearly with respect to the actuator along the linear axis.

13. The battery swapping assembly as recited in claim 9, wherein the actuator causes the battery arm to move with respect to the UAV along a second axis of movement.

14. The battery swapping assembly as recited in claim 13, wherein the second axis of movement comprising a rotational axis of movement around a main body of the UAV.

15. The battery swapping assembly as recited in claim 9, wherein the alignment assembly further comprises an alignment arm that couples the actuator to the battery arm.

16. The battery swapping assembly as recited in claim 15, wherein the actuator causes the battery arm to move along the first axis with respect to the linearly arranged battery banks by rotating the arm with respect to the actuator.

17. The battery swapping assembly as recited in claim 15, wherein the actuator causes the battery arm to move along the first axis with respect to the linearly arranged battery banks by causing the battery arm to move linearly along the alignment arm.

18. A method comprising:
removing a battery assembly from within an unmanned aerial vehicle (UAV) by causing a battery arm to grip a first end of the battery assembly and retract from the UAV;
aligning the battery arm with an opening of a first battery bank of a plurality of battery banks that are linearly arranged within an unmanned aerial vehicle ground station (UAVGS) by causing the battery arm to move along an axis of movement within the UAVGS; and
inserting the battery assembly within the opening of the first battery bank by causing the battery arm to selectively extend towards the first battery bank while the battery arm grips the first end of the battery assembly.

19. The method as recited in claim 18, further comprising charging the battery assembly while the battery assembly is inserted within the first battery bank.

20. The method as recited in claim 18, further comprising:
aligning the battery arm with an opening of a second battery bank having a replacement battery assembly inserted therein by causing the battery arm to move along the axis of movement;
removing the replacement battery assembly from within the second battery bank by causing the battery arm to grip a first end of the replacement battery assembly and retract from the second battery bank;
aligning the battery arm with the UAV by causing the battery arm to move along the axis of movement towards the UAV; and
inserting the replacement battery assembly within the UAV by causing the battery arm to selectively extend towards the UAV while the battery arm grips the first end of the replacement battery assembly.
